(19) United States
(12) Patent Application Publication
(10) Pub. No.: US 2015/0324022 A1
(43) Pub. Date: Nov. 12, 2015

(54) INPUT DEVICE

(71) Applicant: Sony Corporation, Tokyo (JP)

(72) Inventors: Takashi Tsurumoto, Saitama (JP); Takayoshi Yamasaki, Tokyo (JP); Naoki Sugita, Tokyo (JP)

(21) Appl. No.: 14/410,336

(22) PCT Filed: May 17, 2013
(86) PCT No.: PCT/JP2013/003152

§ 371 Date: Dec. 22, 2014

(30) Foreign Application Priority Data
Jul. 4, 2012 (JP) 2012-150701

(51) Int. Cl. G06F 3/0354; G06F 3/0362

(52) U.S. Cl. CPC G06F 3/03547; G06F 3/0362; G06F 2203/0339

(57) ABSTRACT

There is provided an information input device including an operator on which a user operates a sliding operation in a first direction, a first detection unit disposed at a rear surface of the operator detects a position and a pressure of the sliding operation operated by the user in the first direction, a second detection unit disposed adjacent to the first detection unit parallel to the first direction at the rear surface of the operator detects a position and a pressure of the sliding operation operated by the user in the first direction, a position measurement unit that measures an instructed position in the first direction based on the slide position detected by first detection unit or the second detection unit, and measures an instructed position in a second direction based on a difference of the pressures detected by the first detection unit and the second detection unit respectively.

### TECHNICAL FIELD

The present disclosure relates to an information input device, an information processing apparatus, and a remote control system, that perform an information input operation in two dimensions or in two directions by a user's fingertip operation.

### BACKGROUND ART

In recent years, a touch panel is widely used as a two-dimensional or two-directional coordinates input device, and, for example, is adopted to a notebook computer, a smart phone, a tablet terminal and the like. In the touch panel, since a position touched by a user's fingertip substantially and uniquely corresponds to a desired input position, or a trajectory on the touch panel traced by a fingertip substantially and uniquely corresponds to a vector to be instructed on the screen, the operation is intuitive and easily understandable. In addition, in recent years, combined with the improvement of a detection resolution, a concurrent operation using the plurality of fingers such as a pinch operation on the touch panel is also possible.

However, in order to realize the two-dimensional or two-directional input, it also may be necessary for the touch panel to have a two-dimensional expanded area for the input operations. Therefore, it may not be considered practical that mounting the touch panel on small equipment of which a housing has a narrow surface area or equipment which has a limited area for the installation of a device.

For example, a portable information processing apparatus has been proposed, in which a line-shaped X-axis sensor and Y-axis sensor are disposed respectively along the sides in two directions on the display surface of the information apparatus, and which is capable of inputting the coordinates in X direction and Y direction by sliding the fingertips on the sensors (for example, refer to PTL 1 and PTL2). In such an information processing apparatus, in performing the two dimensional coordinates input by one finger, the operations may be divided into two operations, an operation with respect to the X-axis sensor and an operation with respect to the Y-axis sensor, and it is believed that operating the X-axis sensor and Y-axis sensor at the same time with two fingers may be necessary to get used-to To install two line-shaped sensors on different locations may be subject to restrictions on installation location. In addition, since the X-axis sensor and Y-axis sensor have areas for the individual input operation respectively, the total of two areas becomes large. That is, when viewed as one line-shaped sensor, the sensors may be capable of detecting one direction only.

In addition, a user interface device is proposed that includes a touch strip which has a substantially rectangular shape elongated vertically, and on which a plurality of pressure sensors are aligned in a straight line in a longitudinal direction and a plurality of pressure sensors are disposed in a straight line in a lateral direction so as to intersect the group of pressure sensors aligned in the longitudinal direction (refer to PTL 3). In the user interface device, the plurality of pressure sensors disposed in the longitudinal direction and the lateral direction respectively are all installed on one substrate, thus each mechanism for detecting the slide operation in the longitudinal direction and the lateral direction are the same. Then, the slide operation in the lateral direction is used for an instruction which will be a trigger for performing a mode switching and some processes, while the slide operation in the longitudinal direction has vectorial implications such as a selected position, a moving operation, and a scrolling operation of the display screen. In other words, in the user interface device, in order to make the slide operation in the lateral direction have vectorial implications, a similar number of pressure sensors may be disposed in the lateral direction as well as in the longitudinal direction. Consequently, in order to realize a two-dimensional input, the device area becomes large.

In addition, a multi-directional operation member is proposed, that includes a substrate having a conductive sensor unit for changing an electrostatic capacitance by an approach of a conductive member and an operation unit capable of moving substantially horizontal with respect to the surface of the substrate (for example, refer to PTL 4). Here, the operation unit has a dome section which makes the opening section oppose to the substrate side and an extending section which is extended to the outside from the outer peripheral of the opening section, and includes the conductive member which is in a non-contact state with the sensor unit. In addition, the sensor unit includes a central sensor section provided on the position that overlaps the top of dome section in a pressing direction, and one or more outer peripheral sensor sections provided at the outer side of the central sensor section. Then, the sensor unit is configured so as to detect the horizontal slide with respect to the substrate surface of the operation unit in an X direction and a Y direction. According to the multi-directional operation member, it is possible to perform an X-directional and a Y-directional input on a comparatively small area such as a movable range of the operation unit. However, since both of the X-directional and Y-directional inputs are not inputs of the absolute values, the user does not know how much sliding on the operation unit may be enough for instructing the input in the desired X direction and Y direction, and it is thought that the user sometimes may be confused in the operation. That is, the multi-directional operation member is a device that a skillful use of the operation is necessary.

### CITATION LIST

### Patent Literature

### PTL 1: Japanese Unexamined Patent Application Publication No. 2004-157760

### PTL 2: Japanese Unexamined Patent Application Publication No. 2008-236765

### PTL 3: Japanese Unexamined Patent Application Publication No. 2008-204402

### PTL 4: Japanese Unexamined Patent Application Publication No. 2011-228251

### SUMMARY

### Technical Problem

It is desirable to provide an excellent information input device, an information processing apparatus and a remote control system that are capable of appropriately performing a two-dimensional or two-directional information input by a user's fingertip operation.

It is further desirable to provide an excellent information input device, an information processing apparatus and a remote control system that are capable of appropriately performing two dimensional or two-directional information input on a small area for a fingertip operation.

### Solution to Problem

The present disclosure is made in consideration of the above-described problems. According to an embodiment of the present disclosure, there is provided an information input device including; an operator on which a user operates a sliding operation in a first direction, a first detection unit that is disposed at a rear surface of the operator and detects a position and a pressure of the sliding operation operated by the user on the operator in the first direction, a second detection unit that is disposed adjacent to the first detection unit so as to be parallel to the first direction at the rear surface of the operator, and detects a position and a pressure of the sliding operation operated by the user on the operator in the first direction, a position measurement unit that measures an instructed position in the first direction based on the slide position detected by at least one of the first detection unit or the second detection unit, and measures an instructed position in a second direction orthogonal to the first direction based on a difference of the pressures detected by the first detection unit and the second detection unit respectively.

In the embodiment of the present disclosure, the rear surface of the operator of the information input device described above may include a first opposing surface and a second opposing surface that are parallel to the first direction and intersect at a predetermined angle respectively. The first detection unit may be disposed opposing the first opposing surface and the second detection unit is disposed opposing the second opposing surface, respectively.

In the embodiment of the present disclosure, the operator of the information input device described above may be formed of an elastic material such as a silicon rubber, and may be configured to propagate the pressure applied to the slide position by the user in the first direction, to the first detection unit and the second detection unit.

In the embodiment of the present disclosure, the first detection unit and the second detection unit of the information input device described above may include a plurality of pressure-sensitive elements arranged along the first direction respectively. And, the position measurement unit may be configured to measure the instructed position in the first direction based on the output of the position in the first direction detected by the pressure-sensitive element, on which the detection level peaks, in the first detection unit or the second detection unit, and is configured to calculate an instructed position in a second direction based on the difference between the detection level by the pressure-sensitive elements of the first detection unit and the second detection unit which are located on the same position in the first direction.

In the embodiment of the present disclosure, the first detection unit of the information input device described above may be formed of a plurality of pressure-sensitive elements arranged on a first substrate disposed opposing the first opposing surface of the operator along the first direction. In addition, the second detection unit may be formed of a plurality of pressure-sensitive elements arranged on a second substrate disposed opposing the second opposing surface of the operator along the first direction.

In the embodiment of the present disclosure, each pressure-sensitive element of the first detection unit of the information input device described above may be formed of a pressure conductive rubber or a pressure conductive carbon print disposed on the first substrate, and may be configured to contact with a conductor pattern formed on the corresponding position to the first opposing surface to change a resistance value between both ends thereof according to the applied pressure. In addition, each pressure-sensitive element of the second detection unit may be formed of a pressure conductive rubber or a pressure conductive carbon print disposed on the second substrate, and may be configured to contact with a conductor pattern formed on the corresponding position to the second opposing surface to change a resistance value between both ends thereof according to the applied pressure. And, the position measurement unit may be configured to calculate a pressing pressure based on the resistance value of each-pressure-sensitive element.

In the embodiment of the present disclosure, the operator of the information input device described above may include a protrusion formed on the corresponding position to each of the pressure-sensitive element on the first substrates of the first opposing surface with the conductor pattern on an upper surface respectively, and may include a protrusion formed on the corresponding position to each of the pressure-sensitive elements on the second substrates of the second opposing surface with the conductor pattern on an upper surface respectively.

In the embodiment of the present disclosure, the operator of the information input device described above may include a slit that separates each conductor pattern formed on the first opposing surface and the second opposing surface.

Furthermore, according to another embodiment of the present disclosure, there is provided an information processing apparatus including; an information input unit which includes an operator on which a user operates a sliding operation in a first direction, a first detection unit that is disposed at a rear surface of the operator and detects a position and a pressure of the sliding operation operated by the user on the operator in the first direction, a second detection unit that is disposed adjacent to the first detection unit so as to be parallel to the first direction at the rear surface of the operator, and detects a position and a pressure of the sliding operation operated by the user on the operator in the first direction, and a position measurement unit that measures an instructed position in the first direction based on the slide position detected by at least one of the first detection unit or the second detection unit, and measures an instructed position in a second direction orthogonal to the first direction based on a difference of the pressures detected by the first detection unit and the second detection unit respectively, a display unit; and a control unit that controls a screen display on the display unit based on the instructed position in the first direction and the instructed-position in the second direction obtained by the information input unit.

In the embodiment of the present disclosure, the information processing apparatus described above may further include amounting unit that mounts a main body of information processing apparatus main body on the user's head such that the display unit displays an image toward the left and right eyes of the user.

In the embodiment of the present disclosure, the control unit of the information processing apparatus described above may be configured to make a cursor which indicates a horizontally contacted position on the input unit be displayed in the displayed image on the display unit, in response to the contact of the hand fingers to the input unit by the user.

Furthermore, according to another embodiment of the present disclosure, there is provided a remote control system including; a remote control device that includes an operator on which a user operates a sliding operation in a first direction, a first detection unit that is disposed at a rear surface of the operator and detects a position and a pressure of the sliding operation by the user on the operator in the first direction, a second detection unit that is disposed adjacent to the first detection unit so as to be parallel to the first direction at the rear surface of the operator, and detects a position and a pressure of the sliding operation by the user on the operator in the first direction, a position measurement unit that measures an instructed position in the first direction based on the slide position detected by at least one of the first detection unit or the second detection unit, and measures an instructed position in a second direction orthogonal to the first direction based on a difference of the pressures detected by the first detection unit and the second detection unit respectively, and a transmission unit for transmitting a remote control signal based on the instructed position in the first direction and the instructed position in the second direction measured by the position measurement unit, and a display device that includes a display unit, a receiving unit for receiving the remote control signal from the remote control device, and a control unit that controls a screen display on the display unit based on the remote control signal received by the receiving unit.

However, a “system” described here refers to a logically collected plurality of apparatuses (or functional modules which realize a specific function), and whether or not each apparatus or functional modules are equipped in a single enclosure is not particularly limited.

### Advantageous Effects of Invention

According to the present disclosure, it is possible to provide an excellent information input device, an information processing apparatus and a remote control system that are capable of appropriately performing a two-dimensional or two-directional information input by a user's fingertip operation.

According to the present disclosure, it is possible to provide an excellent information input device, an information processing apparatus and a remote control system that are capable of determining the plane position even with the line-shaped device and performing a two-dimensional or two-directional input on a small area.

The other goals, characteristics and advantages in this disclosure will be apparent from the detailed description based on embodiments described below and the accompanying drawings.

### BRIEF DESCRIPTION OF DRAWINGS

FIG. 1 is a diagram illustrating a state of an information input device according to an embodiment of the present disclosure in the present description viewed from an operation surface.

FIG. 2 is a diagram illustrating a state of the information input device viewed from a rear surface side opposite to the operation surface.

FIG. 3 is a diagram illustrating a cross section when the information input device is cut by a plane orthogonal to a horizontal direction.

FIG. 4 is a diagram for describing a method in which the information input device detects a user's fingertip operation in a horizontal direction.

FIG. 5A is a diagram illustrating a state of an operation of one sensor element.

FIG. 5B is a diagram illustrating a state of an operation of one sensor element.

FIG. 6A is a diagram illustrating a state of a horizontal position detected in the information input device as a horizontal position of a pointer on the GUI screen.

FIG. 6B is a diagram illustrating a state of calculated moving amount of the pointer in a vertical direction on the GUI screen based on the vertical position detected in the information input device.

FIG. 7 is a diagram for describing a method in which the information input device detects the user's fingertip operation in the vertical direction.

FIG. 8 is a diagram for describing a method in which the information input device detects the user's fingertip operation in the vertical direction.

FIG. 9 is a diagram for describing a method in which the information input device detects the user's fingertip operation in the vertical direction.

FIG. 10 is a diagram illustrating a modification example of an operator.

FIG. 11 is a diagram illustrating an operation example of the operator illustrated in FIG. 10.

FIG. 12A is a diagram illustrating a configuration example of a sensor element (in a case of being configured in a pressure conductive rubber) used in a first in-line sensor 120 and a second in-line sensor 130.

FIG. 12B is a diagram illustrating a configuration example of a sensor element (in a case of being configured in a pressure conductive rubber) used in a first in-line sensor 120 and a second in-line sensor 130.

FIG. 13A is a diagram illustrating a configuration example of a sensor element (in a case of being configured in a pressure conductive carbon printer) used in a first in-line sensor 120 and a second in-line sensor 130.

FIG. 13B is a diagram illustrating a configuration example of a sensor element (in a case of being configured in a pressure conductive carbon printer) used in a first in-line sensor 120 and a second in-line sensor 130.

FIG. 14 is a schematic diagram illustrating a configuration of a processing unit that processes detection signals from each sensor element of the first in-line sensor and each sensor element of the second in-line sensor.

FIG. 15 is a diagram illustrating a result of the signal processing in the processing unit when the user's fingertip slides in a horizontal direction from the substantially vertical center position of an operation surface in the operation unit.

FIG. 16 is a diagram illustrating a result of the signal processing in the processing unit when the user's fingertip slides in the horizontal direction from the vertical upper position of the operation surface in the operation unit.

FIG. 17 is a diagram illustrating a result of the signal processing in the processing unit when the user's fingertip slides in the horizontal direction from the vertical lower position of the operation surface in the operation unit.

FIG. 18 is a diagram illustrating a result of the signal processing in the processing unit when a multi-touch is performed by two fingers.

FIG. 19 is a diagram for describing a method for calculating a horizontal position of a fingertip using detection signals from the first in-line sensor.

FIG. 20 is a diagram for describing a method for calculating a horizontal position of a fingertip using detection signals from the first in-line sensor.

FIG. 21 is a diagram for describing a method for calculating a horizontal position of a fingertip using detection signals from the first in-line sensor and the second in-line sensor.

FIG. 22 is a flowchart illustrating a process sequence for obtaining two dimensional position information in the processing unit 1400 based on the detection signals from the first in-line sensor and the second in-line sensor.

FIG. 23A is a diagram illustrating an example of applying the information input device to a notebook computer.

FIG. 23B is a diagram illustrating an example of applying the information input device to a notebook computer.

FIG. 24 is a diagram illustrating an example of applying the information input device according to an embodiment, to a remote control device.

FIG. 25 is a diagram illustrating a state of moving a pointer on the TV screen using the information input device on the remote control device illustrated in FIG. 24.

FIG. 26 is a diagram illustrating an example of applying the information input device to a head mounting type display apparatus.

FIG. 27 is a diagram illustrating a state of placing the cursor such that the center line of the line of sight and the operating finger are aligned in a straight line on the display image fused in the user's brain.

FIG. 28 is a diagram illustrating an example of a configuration of the information input device installed in a curved-shape for mounting on a head mounting type display apparatus.

FIG. 29 is a diagram schematically illustrating a functional configuration of an information processing apparatus using the information input device as an input unit.

### DESCRIPTION OF EMBODIMENTS

Hereafter, embodiments of the present disclosure will be described in detail with reference to the drawings.

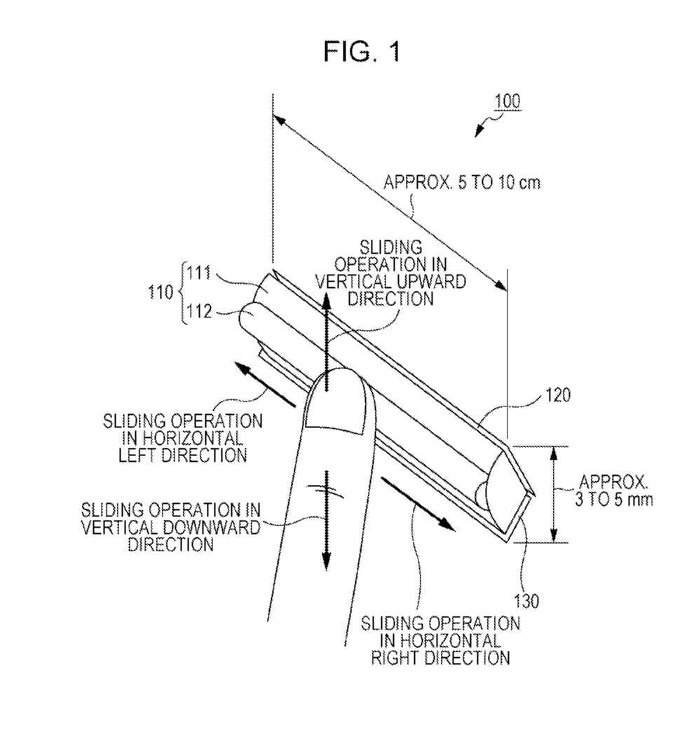

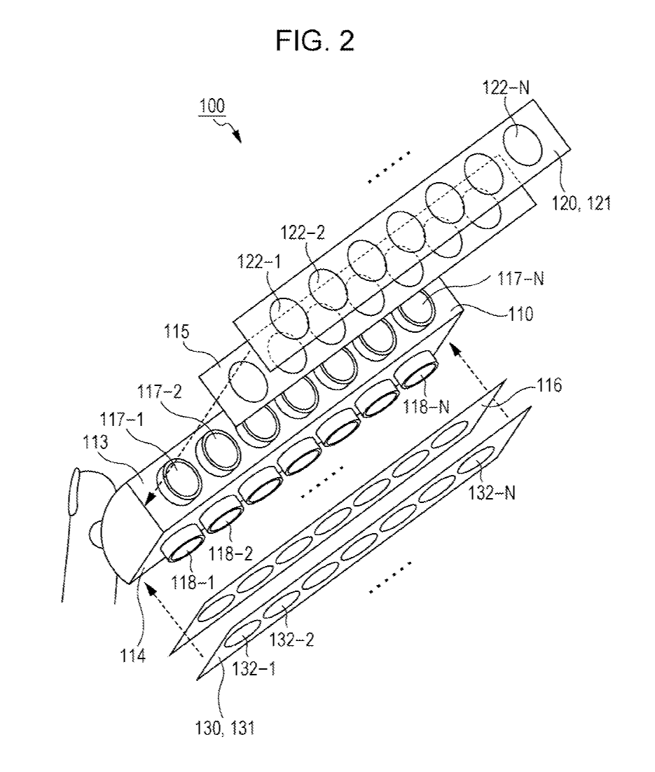

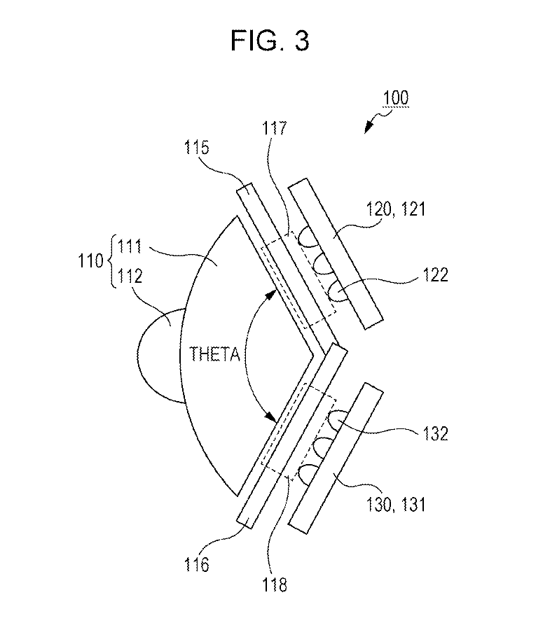

In FIG. 1, a state of an information input device 100 according to an embodiment of the present disclosure viewed from an operation surface is illustrated. In addition, in FIG. 2, a state of the information input device 100 viewed from a rear surface side opposite to the operation surface, and in FIG. 3, a cross section when the information input device 100 is cut by a plane orthogonal to a longitudinal direction, are illustrated.

The information input device 100 includes an operator 110 on which a user performs a sliding operation by sliding a fingertip, a first in-line sensor 120 and a second in-line sensor 130 that are disposed at a rear surface of the operator 110, and a processing unit (not illustrated in FIG. 1 to FIG. 3) that processes detection signals from the first in-line sensor 120 and the second in-line sensor 130.

The operator 110 is composed of a columnar body having two substantially fan-shaped congruent planar figures as bottom surfaces. The side surface of the columnar body equivalent to the arc of the fan shape configures an operation surface 111 on which the user performs a sliding operation by sliding a fingertip. In addition, at substantially center of the operation surface 111, in order to guide the user's fingertip operation, a protruding-shaped guide section 112 is provided along the height direction of a columnar body, that is, in a longitudinal direction.

In addition, one side surface equivalent to the radius of the fan-shaped cross section of the operator 110 configures a first opposing surface 113 facing the first in-line sensor 120, and the other side surface configures a second opposing surface 114 facing the second in-line sensor 130. Moreover, in order to maintain the relative position, a spacer 115 is disposed between the first opposing surface 13 and the first in-line sensor 120, and in order to maintain the relative position, a spacer 116 is disposed between the second opposing surface 114 and the second in-line sensor 130.

As illustrated in FIG. 3, a center angle of the fan-shaped cross section of the operator 110 is set to theta. Therefore, the first opposing surface 113 and the second opposing surface 114 are parallel planes in the longitudinal direction of the operator 110 and are crossed at an angle theta.

The operator 110, for example, is formed of an elastic body such as silicon rubber, and is integrally formed with the guide section 112 provided as protruding on the operation surface 111. When the user's fingertip slides on the operation surface 111 in a longitudinal direction along the guide section 112, the operator 110 deforms downward at the current position of the fingertip, and results to press the first in-line sensor 120 and the second in-line sensor 130 at the corresponding position of the first opposing surface 113 and the second opposing surface 114 respectively. In the description below, the information input device 100 is used such that the user slides the fingertip on the operation surface 111 in a horizontal direction by disposing the operator 110 such that the longitudinal direction thereof is horizontal.

The first in-line sensor 120 is configured to align a plurality (N) of sensor elements 122-1, 122-2, . . . , 122-N in a row in a longitudinal direction of an elongated substrate 121, and is disposed facing the first opposing surface 113 such that the alignment-direction of the sensor elements 122-1, . . . becomes parallel to the longitudinal direction of the operator 110, that is, the horizontal direction. Similarly, the second in-line sensor 130 is configured to align a plurality (N) of sensor elements 132-1, 132-2, . . . , 132-N in a row in a longitudinal direction of an elongated substrate 131, and is disposed facing the second opposing surface 114 such that the alignment direction of the sensor elements 132-1, . . . becomes parallel to the longitudinal direction of the operator, that is, the horizontal direction. As described above, since the first opposing surface 113 and the second opposing surface 114 are crossed at the angle theta, the first in-line sensor 120 and the second in-line sensor 130 are also crossed at the angle theta.

The sensor elements 122-1, . . . , 132-1 . . . used in each of the in-line sensors 120 and 130 are devices in which a conductivity or an electric resistance value is changed according to the applied pressure, and it is possible to configure by using materials such as a pressure conductive rubber or a pressure conductive carbon print.

On the first opposing surface 113 of the operator 110 side, cylindrical protrusions are formed at each position abutting each sensor elements 122-1, 122-2, . . . 122-N of the first in-line sensor 120 side respectively, and N conductor patterns 117-1, 117-2, . . . 117-N are formed on the upper surface of the cylindrical protrusions by a printing or a vapor disposition. Similarly, on the second opposing surface 114 of the operator 110 side, cylindrical protrusions are formed at each position abutting each sensor elements 132-1, 132-2, . . . 132-N of the second in-line sensor 130 side respectively, and N conductor patterns 118-1, 118-2, . . . 118-N are formed on the upper surface of the cylindrical protrusions by a printing or a vapor disposition.

The information input device 100 according to the present embodiment is disposed in an information apparatus (not illustrated) such that the longitudinal direction of the operator 110 becomes the horizontal direction. The user basically slides the fingertip in a horizontal direction on the operation surface 111. Thus, the information input device 100 can measure an absolute position in a horizontal direction by such a fingertip and calculate the relative moving amount in a vertical direction. Firstly, the method for detecting the operation of the user's fingertip in a horizontal direction in the information input device 100 will be described.

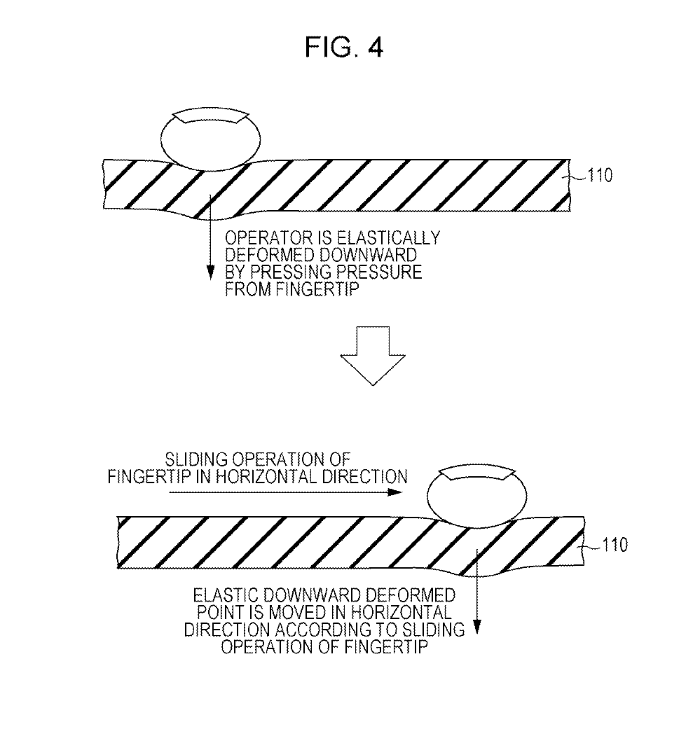

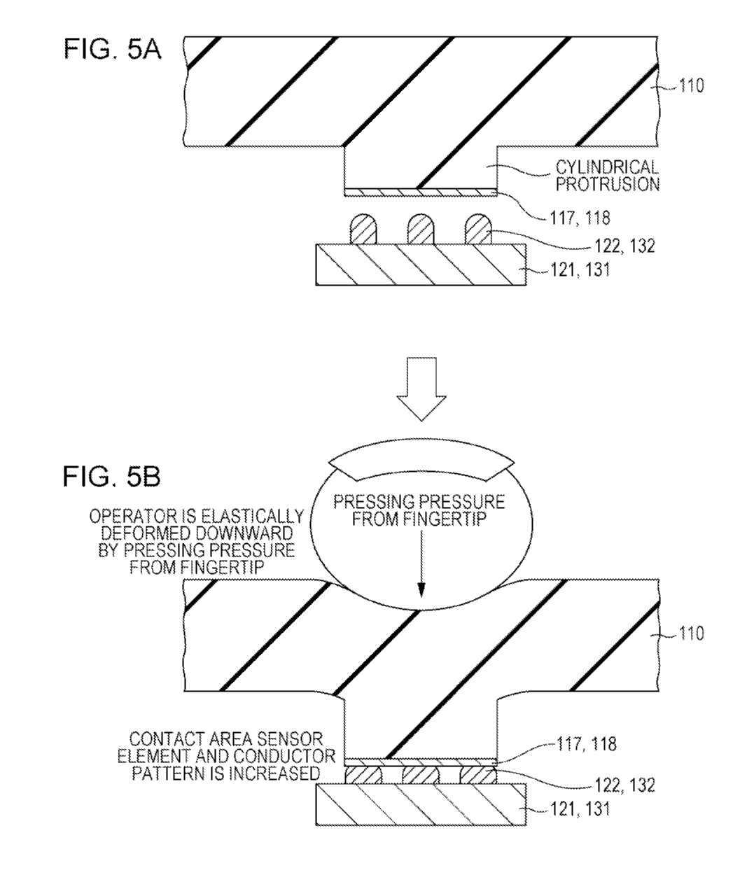

As illustrated in FIG. 4, on the operation surface 111, at a point which is pressed by the user's fingertip, the operator 110 is elastically deformed downward. In addition, when the user's fingertip slides on the operation surface 111 (along the guide section 112) in a horizontal direction, the downward deformed point of the operator 110 also moves in a horizontal direction so as to follow the fingertip's horizontal-position. Then, as illustrated in FIG. 5, on the downward deformed point of the operator 110 (that is, the current position of the fingertip), the sensor elements formed of the pressure conductive rubber or the pressure conductive carbon print is pressed to crush by the cylindrical protrusion formed on the rear surface side of the operator 110. As a result, a contact area of the sensor element and the conductor pattern on the upper surface of the cylindrical protrusion is increased and the electric resistance value of the sensor element is decreased. Therefore, by the electric current increase which flows between the terminals connected to both ends of each sensor element, or by the voltage decrease between the terminals, it is possible to detect which of the plurality of sensor elements 122-1, 122-2, . . . . , 122-N and 132-1, 132-2, . . . , 132-N aligned in a line is pressed, in other words, to detect the horizontal position where the user's finger tip is contacted on the operation surface 111.

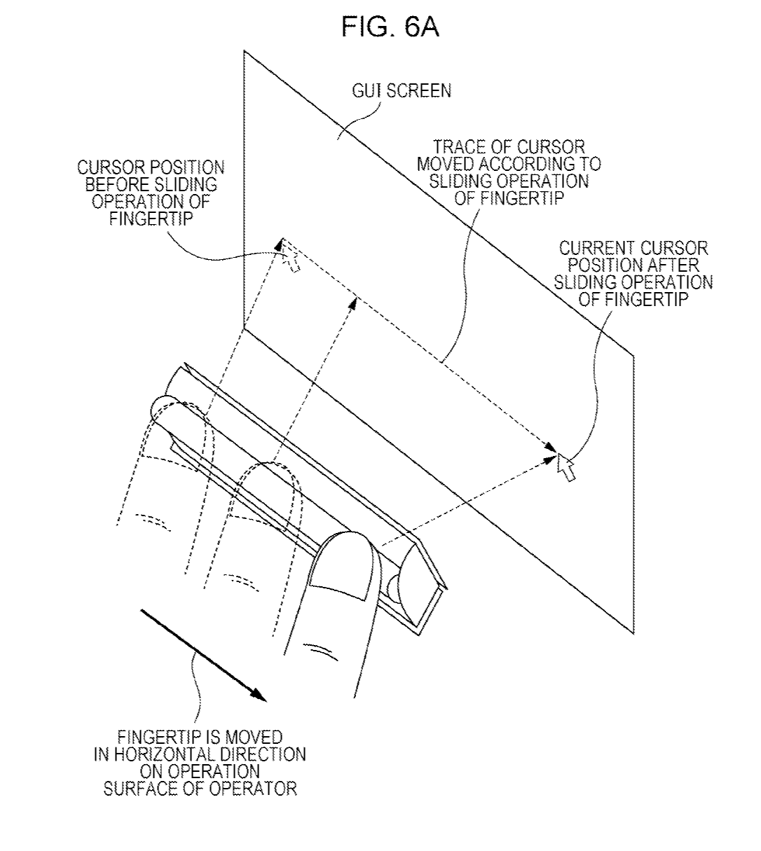

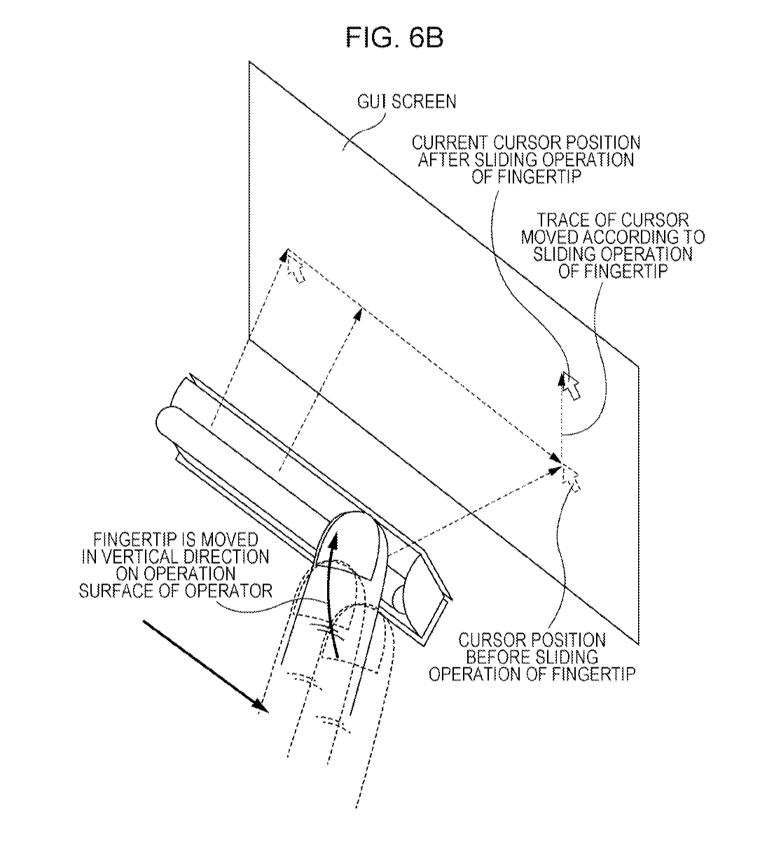

As illustrated in FIG. 2, the first in-line sensor 120 is configured to align the plurality of sensor elements 122-1, 122-2, . . . , 122-N in a line in the longitudinal direction of the elongated substrate 121, that is, the horizontal direction. In addition, the second in-line sensor 130) is configured to align the plurality of sensor elements 132-1, 132-2, . . . , 132-N in a single line in the longitudinal direction of the elongated substrate 131, that is, the horizontal direction. Therefore, by the information input device 100 according to the present embodiment, it is possible to measure the absolute value of the horizontal position. A resolution can be improved by an interpolation calculation of the detection signal between the sensor elements. In addition, as illustrated in FIG. 6A, it is possible to make the detected horizontal position on the information input device 100 be a horizontal position of the pointer on the GUI (Graphical User Interface) screen, or be an absolute moving amount.

Furthermore, providing the cylindrical protrusions at each position abutting each sensor elements 122-1, 122-2, . . . 122-N of the first in-line sensor 120 side and providing the cylindrical protrusion at each position abutting each sensor elements 132-1, 132-2, . . . 132-N of the second in-line sensor 130 side is to keep the insulation between the adjacent abutting conductor patterns 117-1, 117-2, . . . , 117-N and 118-1, 118-2, . . . , 118-N even in a state of being pressed to crush, and is to prevent the erroneous detection. In a case where the insulation between the adjacent conductor patterns can be kept, the protrusion may not be necessary.

Subsequently, the method for detecting the operation of the user's fingertip in a vertical direction in the information input device 100 will be described.

The first in-line sensor 120 and second in-line sensor 130 are disposed so as to cross parallel to the height direction of the columnar body forming the operator 110, that is, the horizontal direction, at the angle theta, and to face the first opposing surface 113 and the second opposing surface 114 of the operator 110, respectively.

As described above, on the operation surface 111 of the operation unit 110, the position where the user's fingertip operates is pressed down, and by an output of the detection signal from the sensor element corresponding to the pressed horizontal position among the sensor elements of the first in-line sensor 120 and the second in-line sensor 130, the operation position in the horizontal direction can be specified.

Here, since the first in-line sensor 120 and the second in-line sensor 130 are crossed each other, when the user's fingertip presses down in a vertical direction, a difference in detection signal between the same i th sensor elements 122-i and 132-i on the horizontal position in the first in-line sensor 120 and the second in-line sensor 130 may easily occur.

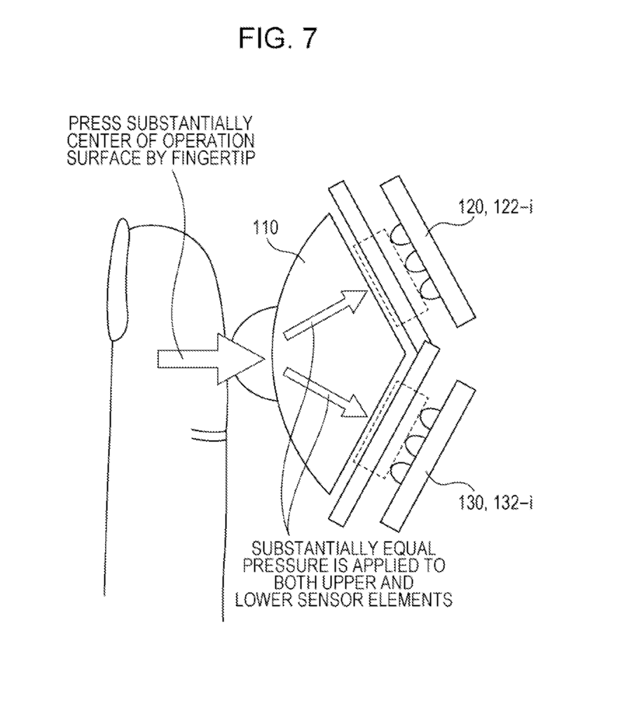

FIG. 7 illustrates a state of an operation on the operation surface 111 by placing the user's fingertip on substantially center of the operation surface 111 of the operator 110 in a vertical direction. In this case, the fingertip is operated on the corresponding horizontal position where the i th sensor elements 122-i and 132-i are disposed.

Since the fingertip presses down the upper part of the guide section 112, that is, substantially center of the operation surface 111 in the vertical direction, compression ratio on the upper half and lower half of the operator 110 on the position where the fingertip is abutting, is substantially the same. Therefore, in the bottom surface side of the-operator 110, the pressing pressure is almost evenly divided into the first opposing surface 113 and the second opposing surface 114. The substantially equal pressure is applied to the same horizontal position i of the first in-line sensor 120 and the second in-line sensor 130. In this case, the pressing pressures obtained from the detection signals of the sensor elements 122-i and 132-i respectively are substantially the same.

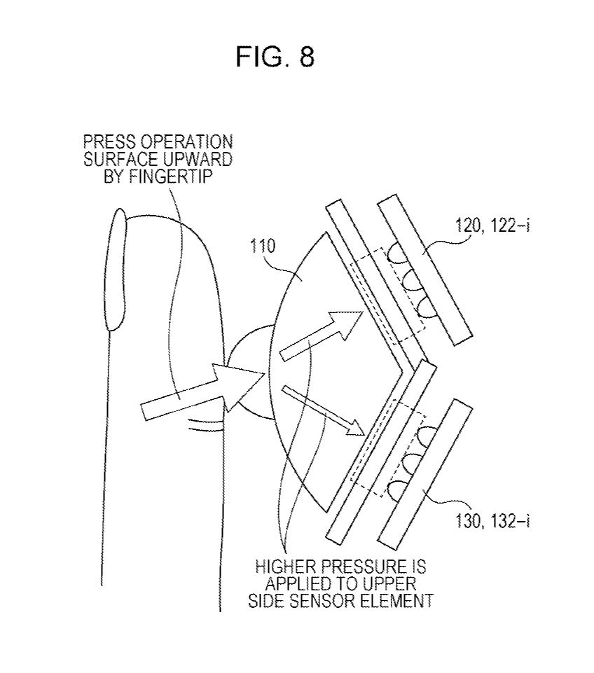

On the other hand, FIG. 8 illustrates a state of an operation on the operation surface 111 by placing the user's fingertip on the upper part than the substantially center of the-operation surface 111 of the operator 110 in a vertical direction. In this case, the fingertip is operated on the corresponding horizontal position where the i th sensor elements 122-i and 132-i are disposed.

Since the fingertip presses down the upper part than the substantially center of the operation surface 111 in the vertical direction, compression ratio on the upper half is higher than that of the lower half of the operator 110 on the position where the fingertip is in contact with. Thus, the operator 110 deforms more largely toward the first opposing surface 113 than toward the second opposing surface 140. Therefore, even on the same horizontal position i, the more pressure is applied to the first in-line sensor 120 than to the second in-line sensor 130. In this case, the pressing pressure obtained from the detection signal of the sensor element 122-i is higher.

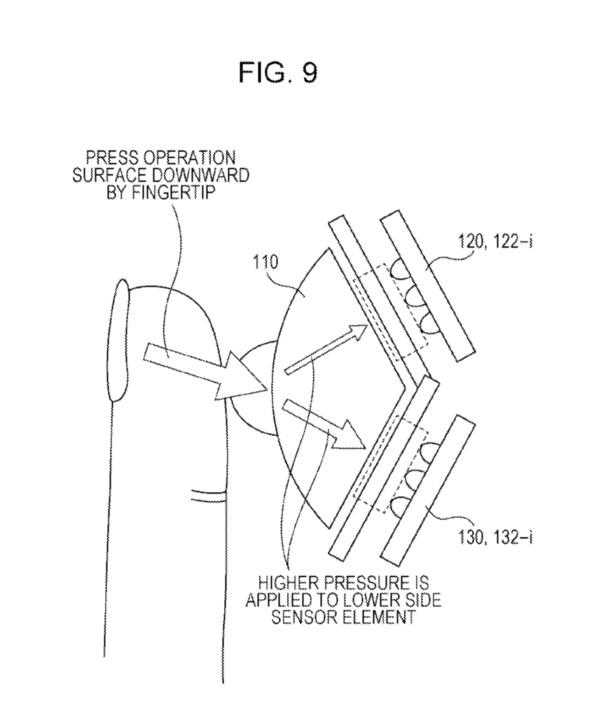

In addition, FIG. 9 illustrates a state of an operation on the operation surface 111 by placing the user's fingertip on the lower part than the substantially center of the-operation surface 111 of the operator 110 in a vertical direction. In this case, the fingertip is operated on the corresponding horizontal position where the i th sensor elements 122-i and 132-i are disposed.

Since the fingertip presses down the part that is lower than the substantially center of the operation surface 111 in the vertical direction, compression ratio on the lower half is higher than that of the upper half of the operator 110 on the position where the fingertip is in contact with. Thus, the operator 110 further largely deforms in the second opposing surface 114 direction than in the first opposing surface 113 direction.

Therefore, even on the same horizontal position i, the more pressure is applied to the second in-line sensor 130 than to the first in-line sensor 120. In this case, the pressing pressure obtained from the detection signal of the sensor element 132-i is higher.

Accordingly, as is evident from FIG. 7 to FIG. 9, by taking a difference of the detection signals from sensor elements 122-i and 132-i on the same position i in the first in-line sensor 120 and the second in-line sensor 130, or by taking the compression ratio of the upper part and lower part of the operator 110, it is possible to detect the operation of the user's fingertip in the vertical direction. For example, it is possible to calculate the difference amount or the compression ratio of the upper part and lower part of the operator 110 as the relative moving amount of the pointer on the GUI screen in the vertical direction. Thus, it is possible to indicate the absolute horizontal position (refer to FIG. 6A) and to input the two dimensional coordinates on the GUI screen (refer to FIG. 6B) by the information input device 100.

For example, as illustrated in FIG. 1, in a case where the information input device 100 is configured to have the operator 110 in a line shape with five to ten centimeters in length and three to five millimeters in width, above described two dimensional coordinate input can be performed with a good operability and the size also can be decreased so as to be sufficiently incorporated in a small information terminal device. However, the gist of the present disclosure is not limited to the size of the information input device 100 in five to ten centimeters in length*three to five millimeters in width.

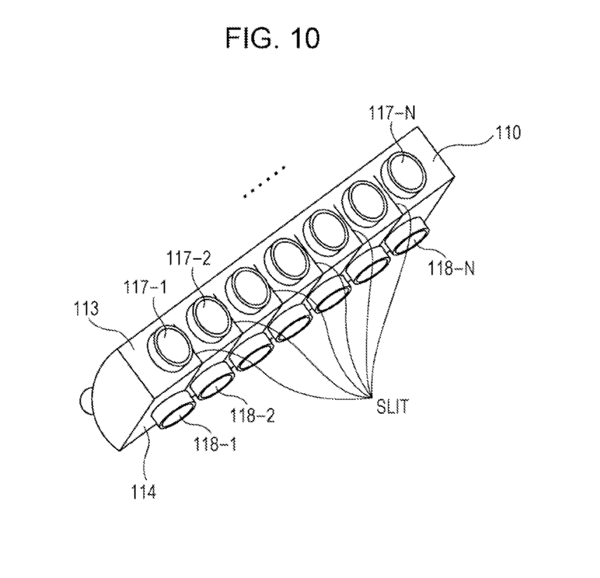

In addition, FIG. 10 illustrates a modification example of the operator 110. The difference from the operator 110 illustrated in FIG. 1 to FIG. 3 is that slits are provided and divide the areas between each of the conductor patterns 117-1, 117-2, . . . 117-N provided on each position abutting each sensor elements 122-1, 122-2, . . . 122-N of the first in-line sensor 120 side, and areas between each of the conductor patterns 118-1, 118-2, . . . 118-N provided on each position abutting each sensor elements 132-1, 132-2, . . . 132-N of the second in-line sensor 130 side.

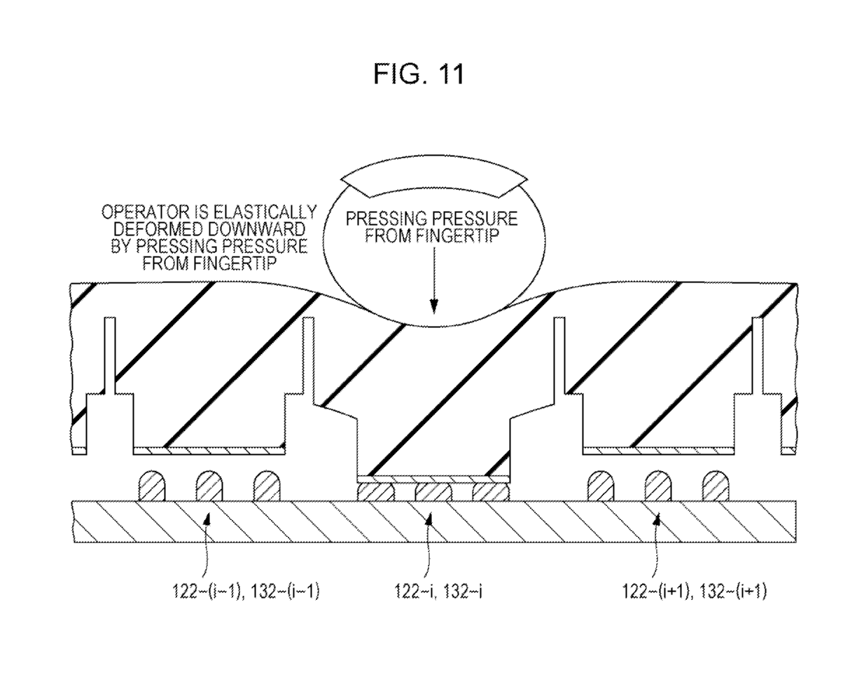

In a case where the slits are provided as illustrated in FIG. 10, on the operator 110, the cylindrical protrusion on the position pressed by a user's fingertip on the operation 111 is deformed downward as illustrated in FIG. 11. However, deforming amount of the adjacent cylindrical protrusion can be suppressed. As a result, only the corresponding sensor elements 122-i and 132-i of the first in-line sensor 120 and the second in-line sensor 130 are allowed to act and the adjacent sensor elements 122-(i+/−1) and 132-(i+/−1) are inhibited to act. Thus, it is possible to improve the position detection resolution.

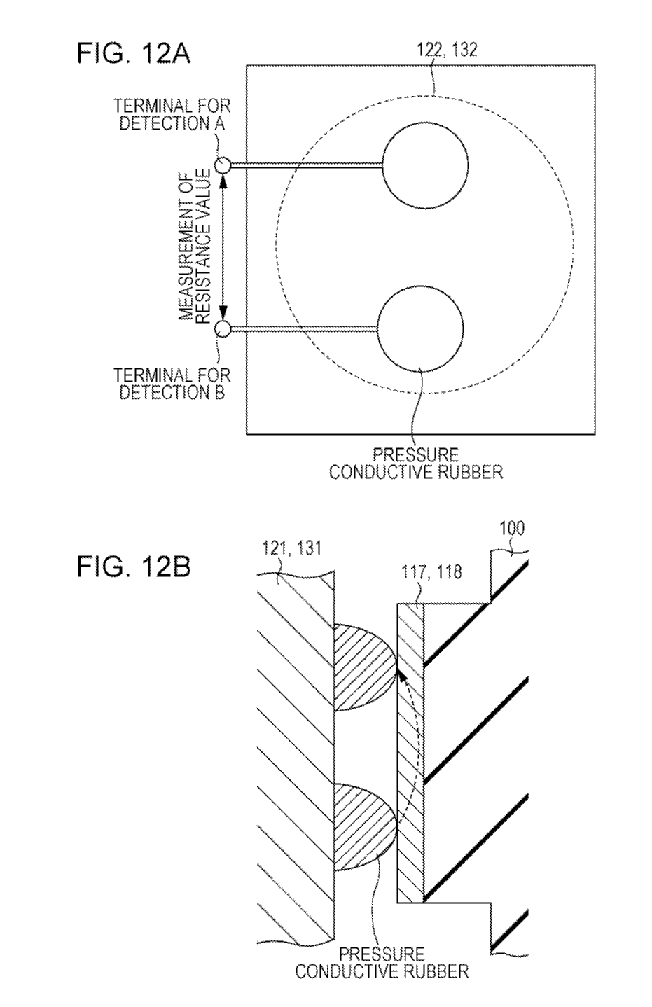

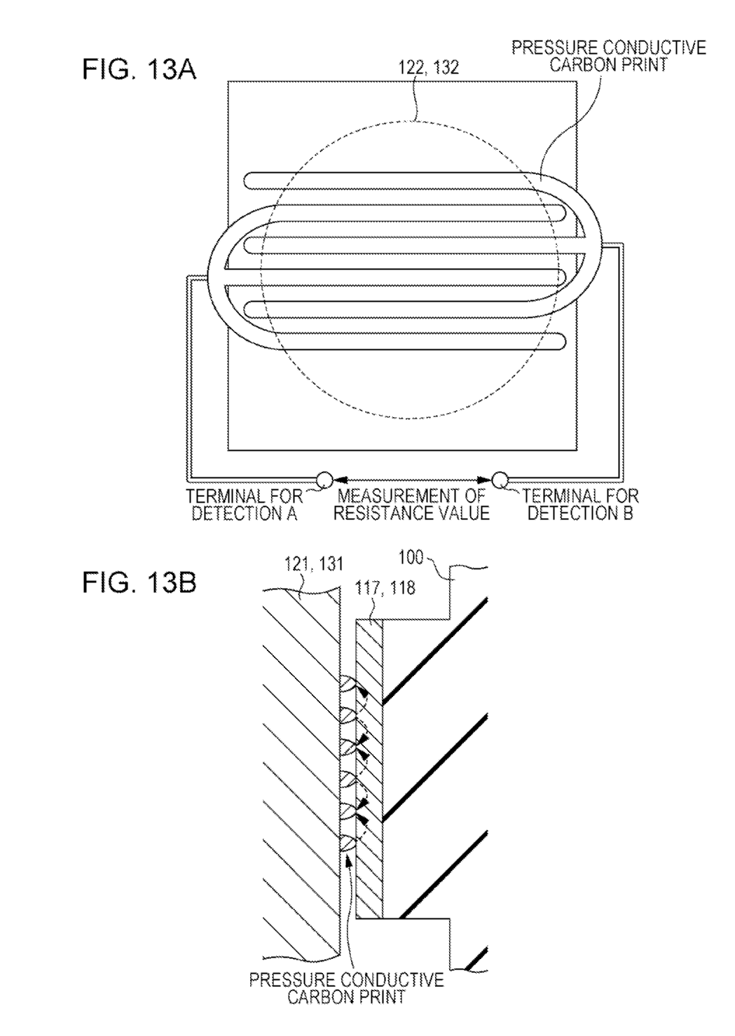

In addition, in FIG. 12A and FIG. 12B, and FIG. 13A and FIG. 13B, configuration examples of a sensor elements used in the first in-line sensor 120 and the second in-line sensor 130 are illustrated respectively. FIG. 12A is a top view of the sensor element in a case of being formed of the pressure conductive rubber. FIG. 13A is a top view of the sensor element in a case of being formed of the pressure conductive carbon print. In any cases, at both ends of the sensor elements, terminals for detection A and B are connected to each other.

Since such the sensor elements as illustrated in FIG. 12A and FIG. 12B, and FIG. 13A and FIG. 13B, are abutting the conductor patterns on the upper surface of the cylindrical protrusion formed on the facing surface of the operator 110 side as illustrated in FIG. 12B and FIG. 13B, terminals for detection on both ends are in the state of being electrically connected to each other (as a dotted line arrow in FIGS. 12A to 13B). Then on the position where the user applies the pressure using the fingertip, by the elastic deform of the operator 110 (refer to FIG. 4), the pressure conductive rubber refer to FIGS. 12A and 12B or the pressure conductive carbon print refer to FIGS. 13A and 13B that configures the sensor elements is pressed to crush by the cylindrical protrusion. As a result, a contact area of the sensor element and the conductor pattern on the protrusion is increased and the electric resistance value between the terminals A and B of the sensor elements is decreased. Therefore, by the electric current increase flows between the terminals connected to both ends of each sensor elements, or by the voltage decrease between the terminals, it is possible to detect which of the plurality of sensor elements 122-1, 122-2, . . . , 122-N and 132-1, 132-2, . . . , 132-N aligned in a line is pressed, and to measure the pressing pressure.

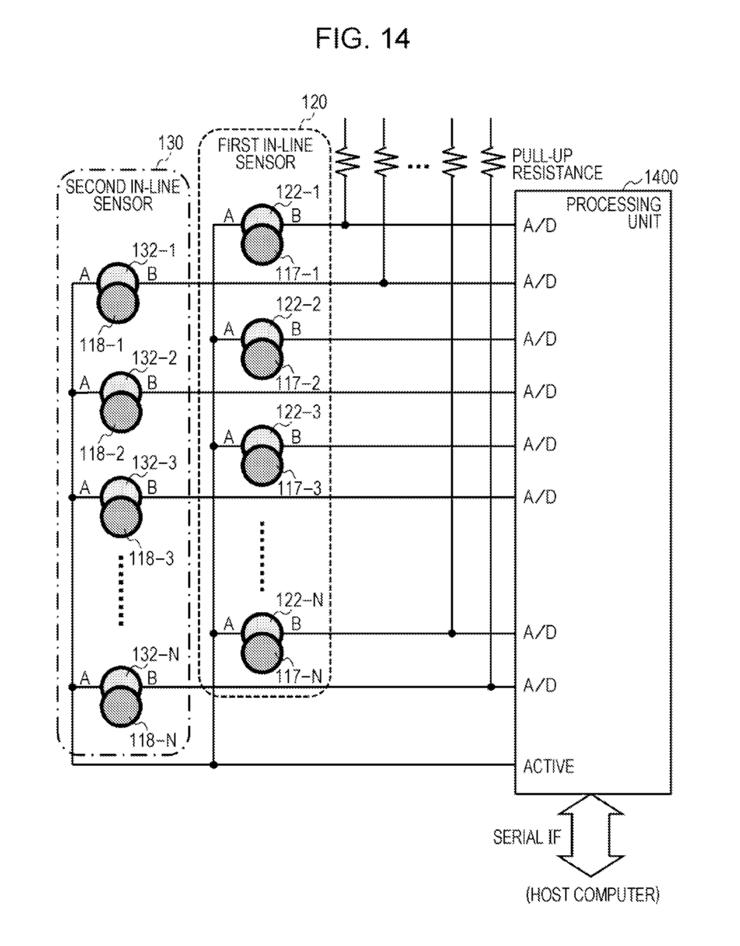

In FIG. 14 schematically illustrates a configuration of a processing unit 1400 that processes the detection signals from each sensor elements 122-1, 122-2, . . . , 122-N of the first in-line sensor 120 and each sensor elements 132-1, 132-2, . . . , 132-N of the second in-line sensor 130.

One end terminal A of each sensor elements 122-1, 122-2, . . . , 122-N and 132-1, 132-2, . . . , 132-N is connected to an active terminal of the processing unit 1400. In-addition, the other end terminal B is pulled-up via a pull-up resistor and is connected to each corresponding A/D input terminals respectively.

On a certain horizontal position i, when the pressure is applied to the operator 110 from the user's fingertip, the cylindrical protrusions on the facing surface 113 and 114 is pushed down, and the conductor patterns contact with the sensor elements 122-i and 132-i. As a result, both ends terminal A and B of the sensor elements 122-i and 132-i in an insulated state becomes conductive via the conductor pattern. Accordingly, the processing unit 1400 is capable of detecting the signals as the voltage decrease between the terminals. In addition, when the pressure applied to the operator 110 by the fingertip becomes higher, as illustrated in FIG. 5 and FIG. 7 to FIG. 9, the pressure conductive rubber or the pressure conductive carbon print that forms the sensor elements 122-i/132-i is pressed to crush and the contact area of the to the conductor pattern is increased and the electric resistance value of the sensor elements 122-i and 132-i is decreased. Thus the electric current flows the terminals A and B is increased or the voltage between the terminals is decreased.

Thus, the processing unit 1400 is capable of A/D converting and taking the electric current signal or the voltage signal of each sensor elements 122-1, 122-2, . . . , 122-N and 132-1, 132-2, . . . , 132-N input from each A/D input terminal and measuring the resistance value of each sensor elements based on the current level or the voltage level. Thus, the processing unit 1400 calculates the pressing pressure applied to each sensor elements from the resistance value. In addition, the processing unit 1400 performs an interpolation calculation of the pressing pressure detected between adjacent sensor elements, and thus, makes it possible to improve the resolution.

Then, the processing unit 1400 outputs the measuring result to a host computer (not illustrated) via the serial interface and the like. The host computer side can convert the-pressing pressure information obtained from two lines, the first in-line sensor 120 and the second in-line sensor 130, to the two dimensional position information, and can use for the moving operation of a pointer on the GUI screen (refer to FIG. 6A and FIG. 6B), and the like.

On the operation surface 111, at the horizontal position touched by the use's fingertip, the detection level, that is, the pressing pressure of the sensor element corresponding to the horizontal position on the first in-line sensor 120 and the second in-line sensor 130 becomes high.

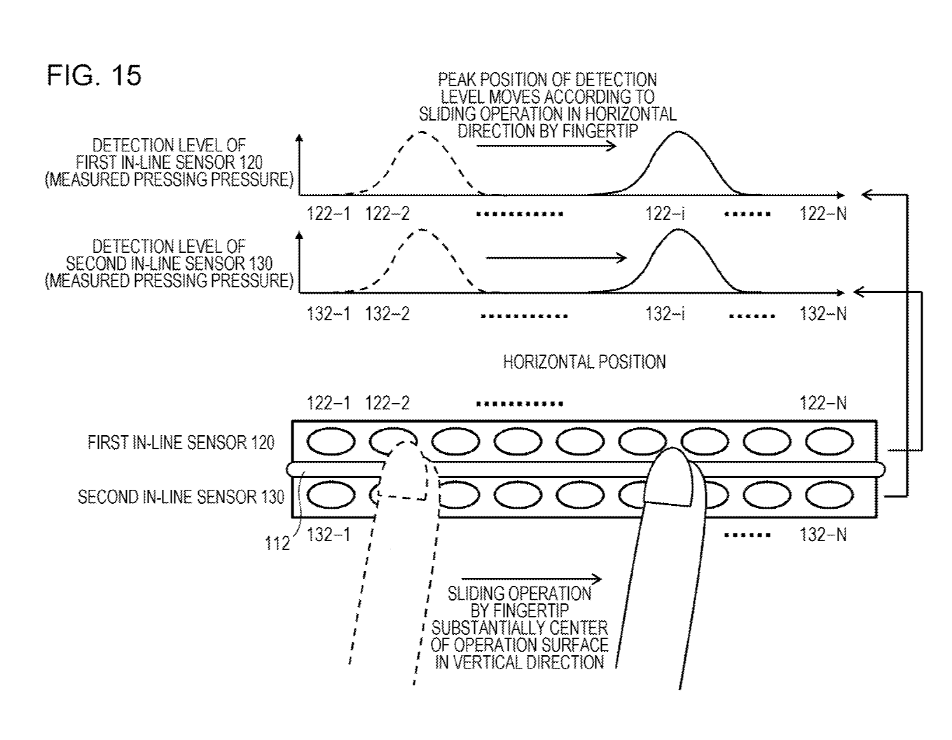

FIG. 15 illustrates a result of the signal processing in the processing unit 1400 when the user's fingertip slides in a horizontal direction from the substantially vertical center-position of an operation surface Ill in the operation unit 110. As illustrated, in accordance with the sliding operation of the user's fingertip in the horizontal direction, the horizontal position where the detection level by the sensor element, that is, the pressing pressure peaks, also moves. In addition, since the user's fingertip presents at the substantially vertical center position of the operation surface 111, the substantially same pressure is applied to the upper half part and lower half part of the operator 110 on the position where the fingertip is in contact with (refer to FIG. 7). Thus, the peak value of the detection level detected on each horizontal position of the first in-line sensor 120 and the second in-line sensor 130 is substantially the same.

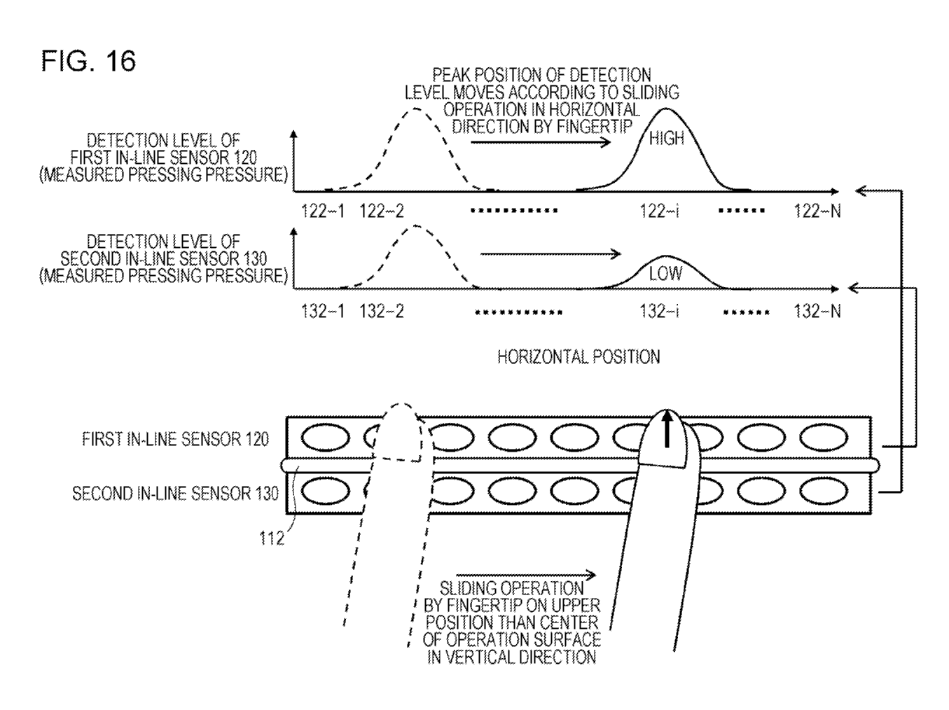

In addition, FIG. 16 illustrates a result of the signal processing in the processing unit 1400 when the user's fingertip slides in the horizontal direction from the vertical upper-position of the operation surface 111 in the operation unit 110. As illustrated, in accordance with the sliding operation of the user's fingertip in the horizontal direction, the horizontal position where the detection level by the sensor element, that is, the pressing pressure peaks, also moves horizontally. In addition, since the user's fingertip presents at the vertically upper position of the operation surface 111, the pressure applied to the upper half is higher than that of the lower half of the operator 110 on the position where the fingertip is abutting (refer to FIG. 8). Thus, the peak value of the detection level detected on each horizontal position of the first in-line sensor 120 is larger than that of the second in-line sensor 130.

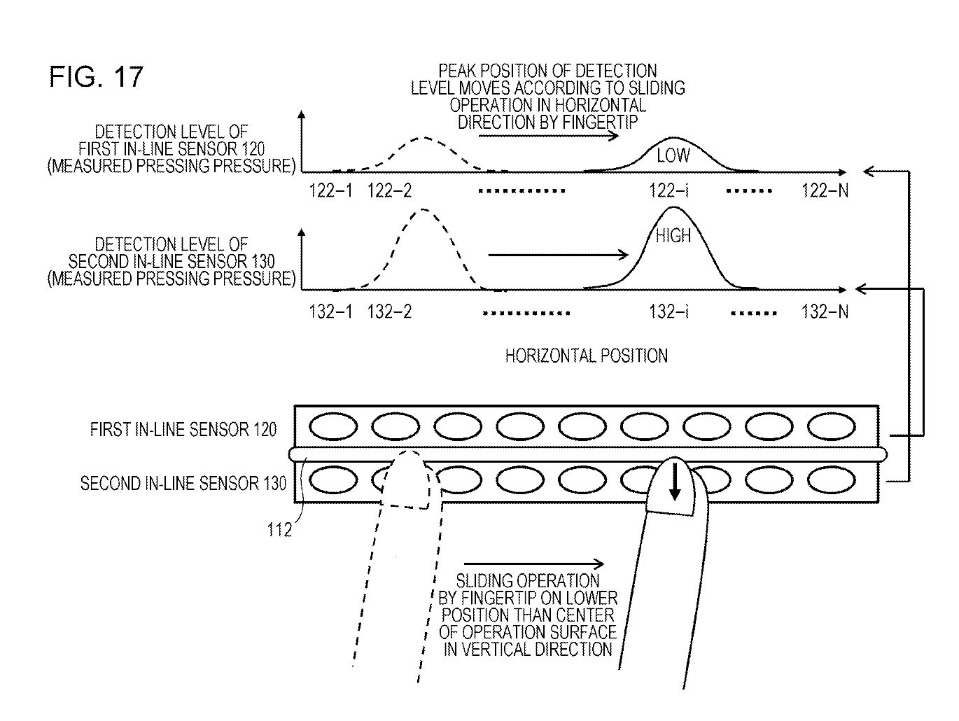

In addition, FIG. 17 illustrates a result of the signal processing in the processing unit 1400 when the user's fingertip slides in the horizontal direction from the vertical lower-position of the operation surface 111 in the operation unit 110. As illustrated, in accordance with the sliding operation of the user's fingertip in the horizontal direction, the horizontal position where the detection level by the sensor element, that is, the pressing pressure peaks, also moves horizontally. In addition, since the user's fingertip presents at the vertically lower position of the operation surface 111, the pressure applied to the lower half is higher than that of the upper half of the operator 110 on the position where the fingertip is abutting (refer to FIG. 9). Thus, the peak value of the detection level detected on each horizontal position of the second in-line sensor 130 is larger than that of the first in-line sensor 120.

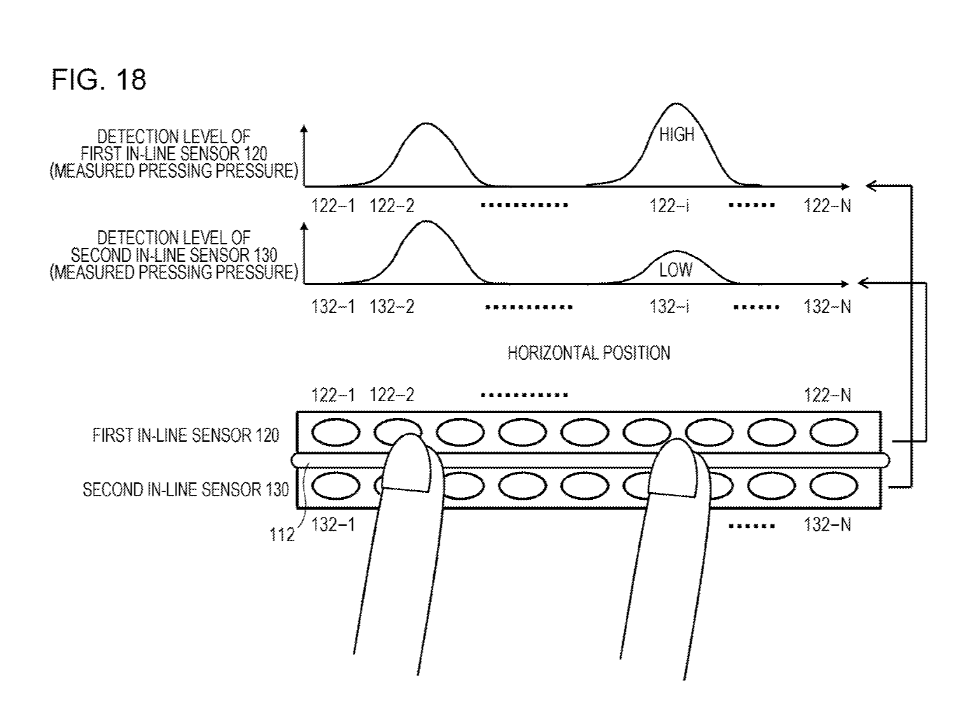

In addition, in a case where a position detection resolution of the first in-line sensor 120 and the second in-line sensor 130 is high enough, a concurrent operation using the plurality of fingers (multi-touch) such as a pinch operation on the operation surface 111 of the operator 110 is also possible. FIG. 18 illustrates a result of the signal processing in the processing unit 1400 when the multi-touch is performed by two fingers. As illustrated, on the horizontal positions of each of the fingertips, the corresponding peak of the detection level is generated. When the pressing pressure of each finger is different, the peak value of the detection level is also different.

In addition, in a case where each finger performs operation in vertically different directions respectively on the operation surface 111, on each of the horizontal positions where the detection level peaks, a magnitude relation of the detection level of the first in-line sensor 120 and the second in-line sensor 130 are all different, it is possible to detect the vertical and horizontal position of each finger.

In the example illustrated in FIG. 18, the left fingertip operates the substantially vertical center position on the operation surface 111, the peak value of the detection level detected by the first in-line sensor 120 and second in-line sensor 130 on that horizontal position is substantially the same. On the other hand, the right fingertip operates the vertical upper position on the operation surface 111, the peak value of the detection level detected by the first in-line sensor 120 on that horizontal position is larger than that of the second in-line sensor 130.

Here, a specific example of a method for calculating the horizontal and vertical position of the fingertip based on the detection signal of the first in-line sensor 120 and the second in-line sensor 130 in the processing unit 1400 will be described.

In case of measuring the horizontal position of the fingertip, only one of the detection signals by any of the first in-line sensor 120 or the second in-line sensor 130 may be used, or both of the detection signals may be used. Here, to make the description simple, a case of calculating the horizontal position of the fingertip using only the first in-line sensor 120 will be described.

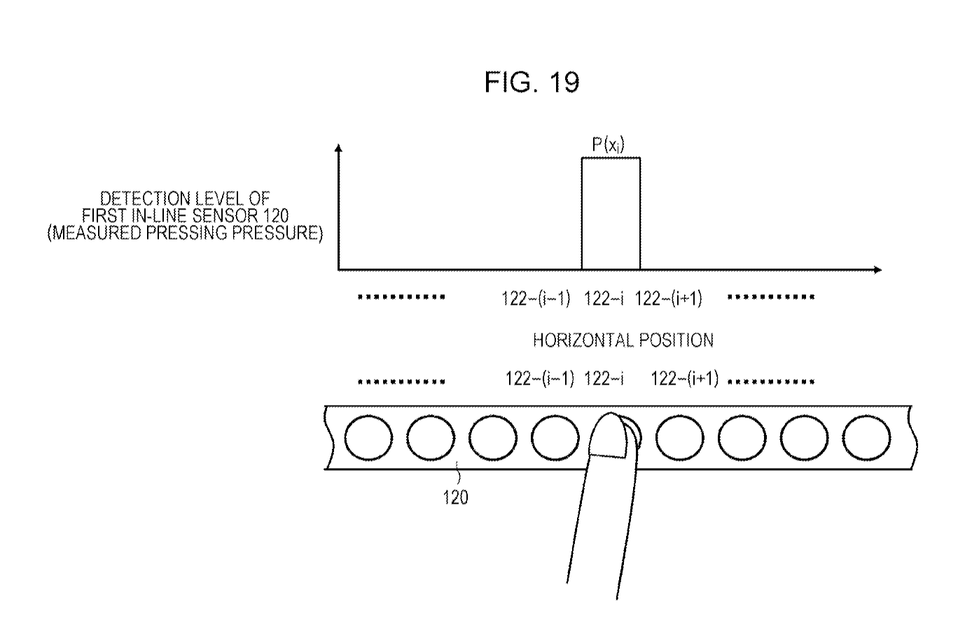

FIG. 19 illustrates a state of the user's fingertip pressing of the position nearly corresponding to just i th sensor element 122-i of the first in-line sensor 120 on the operation surface 111 of the operator 110, along with the detection level of each sensor elements 122-1 . . . at that time. In this case, the detection level appears high only on the sensor element 122-i. Here, when the horizontal position of the fingertip is set to x_{finger}, the horizontal position of the i th sensor element 122-i is set to xᵢ, then the horizontal position of the fingertip x_{finger} can be obtained by following Formula 1.

### [Math. 1]

x_{finger}=xᵢ (1)

In addition, the pressing pressure at the horizontal position x on the operation surface 111 of the first in-line sensor 120 is set to P(x). As illustrated, in a case where the-pressing pressure P(xᵢ) of only one sensor element 122-i is detected, the pressing pressure P(x_{finger}) from the fingertip can be obtained by following Formula 2 in the processing unit 1400.

### [Math.2]

P(x_{finger})=P(xᵢ) (2)

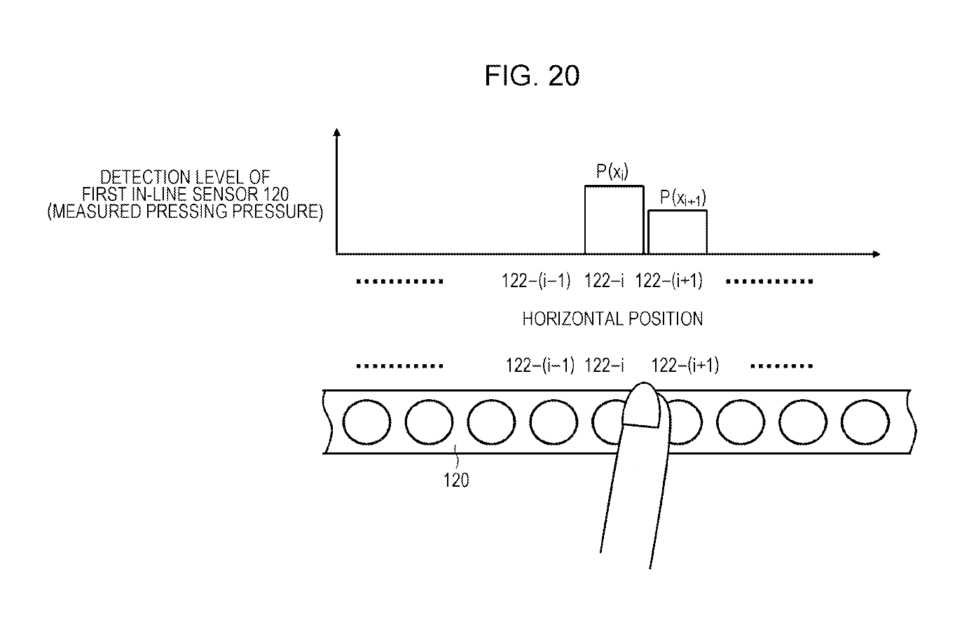

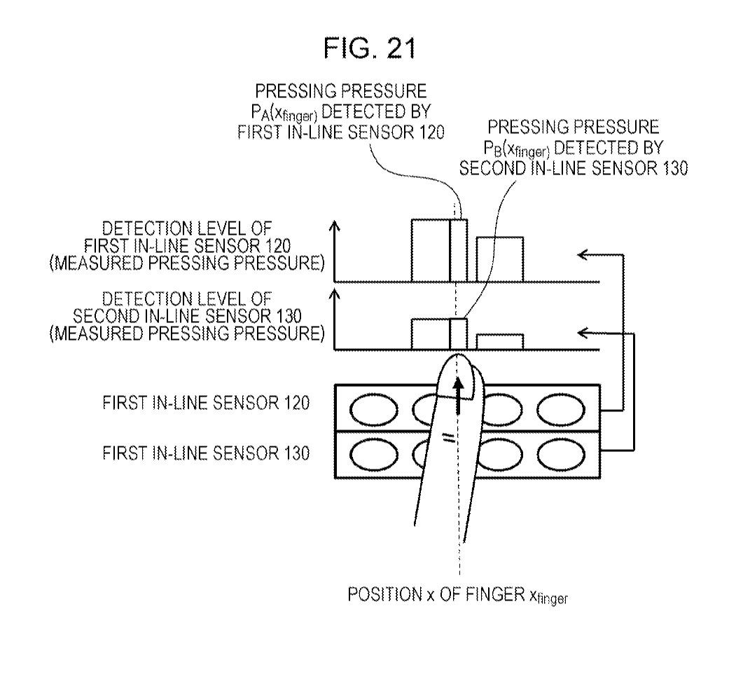

On the other hand, FIG. 20 illustrates a state of the user's fingertip pressing of the position nearly corresponding to between i th sensor element 122-i and (i+1) th sensor element 122-(i+1) of the first in-line sensor 120 on the operation surface 111 of the-operator 110, along with the detection level of each sensor elements 122-1 . . . at that time. In this case, the pressing pressure from the user's fingertip is divided into the sensor element 122-i and 122-(i+1) and appears as each of the detection levels P(xᵢ) and P(xᵢ₊₁). The processing unit 1400 can calculate the pressure P(xᵢ) and P(xᵢ₊₁) applied to the horizontal position x, based on the detection level of each sensor elements 122-i and 122-(i+1).

Here, the horizontal position of the fingertip x_{finger} between the sensor element 122-i and 122-(i+1) is a point on which the pressing pressures P(xᵢ) and P(xᵢ₊₁) of each sensor elements 122-i and 122-(i+1) is internally divided. Therefore, the horizontal position of the fingertip x_{finger} can be obtained by an interpolation calculation by following Formula 3. In short, the above Formula 1 corresponds to the case that the detection level P(xᵢ₊₁) of the sensor element 122-(i+1) is zero in the following formula 3.

$$\begin{matrix}[ Math . 3 ] & \\ {x}_{finger} = {x}_{i} + \frac{P ( {x}_{i + 1} )}{P ( {x}_{i} ) + P ( {x}_{i + 1} )} ( {x}_{i + 1} - {x}_{i} ) & ( 3 )\end{matrix}$$

In addition, when the pressing pressure P(xᵢ) and P(xᵢ₊₁) from the plurality of sensor elements 122-i and 122-(i+1) are detected, as following Formula 4 shows, the processing unit 1400 obtains the maximum value of the pressing pressure as the pressing pressure P(x_{finger}) from the horizontal position of the fingertip x_{finger}. Above Formula 2 corresponds to the case that detected pressing pressure P(xᵢ₊₁) from the sensor element 122-(i+1) is zero.

### [Math.4]

P(x_{finger})=max[P(xᵢ),P(xᵢ₊₁)] (4)

In case of calculating the vertical position of the fingertip, both of the detection signal of the first in-line sensor 120 and the second in-line sensor 130 are used.

FIG. 21 illustrates a state of the user's fingertip pressing of the position corresponding to between i th sensor element 122-i and (i+1) th sensor element 122-(i+1) of the first in-line sensor 120 on the operation surface 111 of the operator 110 in the horizontal direction, and between the first in-line sensor 120 and the second in-line sensor 130 in the vertical direction, along with the detection level of each in-line sensors 120 and 130 at that time. The pressing pressure detected by the first in-line sensor 120 at the horizontal position x is set to P_{A}(x) and the pressing pressure detected by the second in-line sensor 130 at the horizontal position x is set to P_{B}(x). Hereafter, the description will be made under the assumption that the horizontal position x_{finger} of the fingertip is-calculated by above Formula 3 and each pressing pressures P_{A}(x_{finger}) and P_{B}(x_{finger}) detected from each of the line sensors 120 and 130 on the horizontal position x_{finger} is already calculated by above Formula 4.

Which direction in vertical the fingertip is moving, can be determined by comparing two values of each pressing pressures P_{A}(x_{finger}) and P_{B}(x_{finger}) detected by each in-line sensors 120 and 130 on the horizontal position x_{finger} of the fingertip. The processing unit 1400 calculates the difference Direction of the pressing pressures P_{A}(x_{finger}) and P_{B}(x_{finger}) as shown below in Formula 5, and determines the direction in which the fingertip operates in vertical based on the plus/minus sign of Direction as shown in Formula 6 below.

$$\begin{matrix}[ Math . 5 ] & \\ Direction = {P}_{A} ( {x}_{finger} ) - {P}_{B} ( {x}_{finger} ) & ( 5 ) \\ [ Math . 6 ] & \\ \{ \begin{matrix}Direction > \text{:} ↑ DIRECTION \\ Direction < \text{:} ↓ DIRECTION\end{matrix} & ( 6 )\end{matrix}$$

However, when the two-value determination of upward and downward direction is performed by the plus/minus sign of the Direction as shown in Formula 6, there may be a problem in that even a slight movement in the vertical direction during the user's fingertip movement in the horizontal direction may be detected and it may cause a vertical movement of the pointer that the user does not intend. Therefore, in order to avoid such an erroneous operation, the processing unit 1400 performs the determination of the vertical movement only when the absolute value of the Direction exceeds the predetermined threshold value Pₜₕ. In a case where the absolute value is equal to or smaller than the threshold value Pₜₕ, the Direction is ignored, and the horizontal movement only is determined by the processing unit 1400. That is, the processing unit 1400 determines the vertical movement only when the difference of the pressing pressure between the vertically aligned in-line sensors is equal to or greater than the predetermined value.

$$\begin{matrix}[ Math . 7 ] & \\ \{ \begin{matrix}\vert Direction \vert > {P}_{th} \text{:} \begin{matrix}PERFORMS DETERMINATION \\ VERTICAL MOVEMENT\end{matrix} \\ \vert Direction \vert \leq {P}_{th} \text{:} \begin{matrix}ONLY THE HORIZONTAL \\ MOVEMENT\end{matrix}\end{matrix} & ( 7 )\end{matrix}$$

In addition, the pressing pressure from the user's fingertip is divided into those of the first in-line sensor 120 and the second in-line sensor 130, and appear as the pressing-pressures P_{A}(x_{finger}) and P_{B}(x_{finger}) detected by the first in-line sensor 120 and the second in-line sensor 130. Furthermore, the processing unit 1400, as shown in Formula 8, may normalize the difference between the pressing pressures P_{A}(x_{finger}) and P_{B}(x_{finger}) to the maximum value of the pressing pressure to calculate the Direction, and may perform a multi-value determination of the vertical movement of fingertip. In this case also, the processing unit 1400 performs the determination of the vertical movement amount only when the Direction exceeds the predetermined threshold value, that is, when the difference of the pressing pressures between the vertically aligned in-line sensors is equal to or greater than the predetermined value.

$$\begin{matrix}[ Math . 8 ] & \\ Direction = \frac{{P}_{A} ( {x}_{finger} ) - {P}_{B} ( {x}_{finger} )}{max [ {P}_{A} ( {x}_{finger} ) , {P}_{B} ( {x}_{finger} ) ]} & ( 8 )\end{matrix}$$

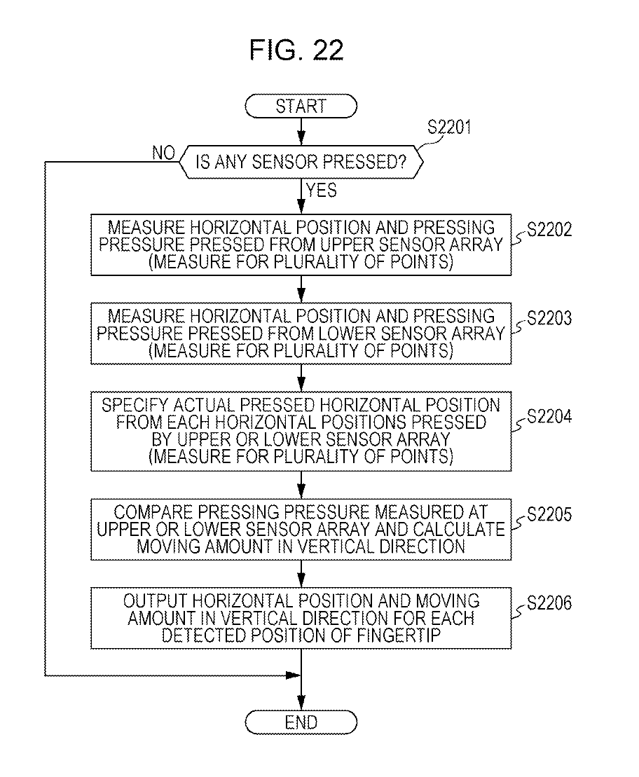

In FIG. 22, a process order by the processing unit 1400 for obtaining two dimensional information of position is illustrated as a form of flow chart based on the detection signals by each sensor elements 122-1, 122-2, . . . , of the first in-line sensor 120 and each sensor elements 132-1, 132-2, . . . , of the second in-line sensor 130. On operations of the operator 110 on the operation surface 111, a few milliseconds or tens of milliseconds in an interval may be necessary for performing each process operations of the movement of the pointer on the GUI screen following the user's fingertip, for example.

First, the processing unit 1400 checks whether or not any of the sensor elements of at least one of the first in-line sensor 120 or the second in-line sensor 130 is pressed down (STEP S2201).

In a case where the pressing operation is not detected (STEP S2201 No), the processing unit 1400 stops the process routine.

On the other hand, when the pressing operation is detected (STEP S2201 Yes), the processing unit 1400 measures the horizontal position x^{A}_{finger} of the sensor element in which the detection level of the pressing pressure peaks from the plurality of the sensor elements 122-1, 122-2, . . . , 122-N of the upper sensor element array, that is, the first in-line sensor 120, and the pressing pressure P_{A}(x^{A}_{finger}) at the horizontal position x^{A}_{finger} (STEP S2202). Here, in a case where the operation is performed with plurality of fingers and the plurality of peaks of detection level is detected, the pressing pressure for each peak is measured.

Next, the processing unit 1400 measures the horizontal position x^{B}_{finger}, of the sensor element in which the detection level of the pressing pressure peaks from the plurality of the sensor elements 132-1, 132-2, . . . , 132-N of the second in-line sensor 130, and the pressing pressure P_{B}(x^{B}_{finger}) at the horizontal position x^{B}_{finger (STEP S2203)}. Here, in a case where the operation is performed with a plurality of fingers and the plurality of peaks of detection level is detected, the pressing pressure for each peaks is measured.

Then, the processing unit 1400 specifies the horizontal position x_{finger} of the user's fingertip based on the horizontal position x^{A}_{finger} detected in STEP S2202 and the horizontal position x^{B}_{finger} detected in STEP S2203 (STEP S2204). Any one of the x^{A}_{finger} or x^{B}_{finger} may be used as the horizontal position x_{finger} the fingertip. Here, in a case where the plurality of fingers is operated on the operation surface 111, the horizontal position for each finger is specified.

Subsequently, the processing unit 1400, at the horizontal position specified as the position of the user's fingertip, compares the pressing pressure P_{A}(x^{A}_{finger}) measured at the first in-line sensor 120 side on STEP S2202 and the pressing pressure P_{B}(x^{B}_{finger}) measured at the second in-line sensor 130 side on STEP S2203, and calculates the moving amount in the vertical direction following to the above Formula 8 (STEP S2205).

Then, the processing unit 1400 outputs the horizontal coordinates and the moving amount in the vertical direction for each horizontal positions specified as a position of the user's fingertip to the host computer, and ends the process routine (STEP S2206).

The information input device 100) according to the present embodiment can be widely applicable to various information processing apparatuses such as a personal computer or a multi-functional mobile terminal to which the two dimensional coordinates input is applicable, as an inputting mechanism.

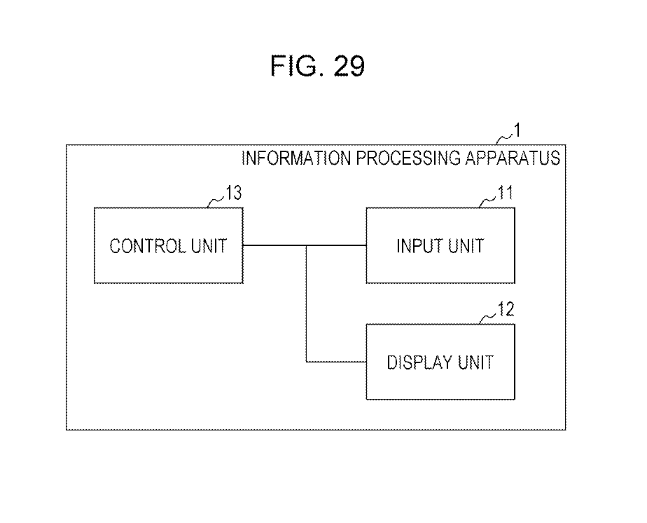

FIG. 29 schematically illustrates a functional configuration of an information processing apparatus 1 using the information input device 100) as an input unit. The input unit 11 has configurations as illustrated in FIG. 1 to FIG. 3 and is capable of inputting the two dimensional coordinates. The display unit 12 includes a display screen formed of a liquid crystal display and the like, and for example, outputs and displays the GUI screen. The control unit 13 controls the screen display on the display unit 12 based on the two dimensional coordinates information formed of the position in the horizontal direction and the moving amount in the vertical direction input from the input unit 111. In addition, the information processing apparatus 1 may include a communication unit that communicates with an external network or a large capacity storage unit that stores the data. However, those are not directly related to the gist of the technologies disclosed herein, the illustration will not be shown.

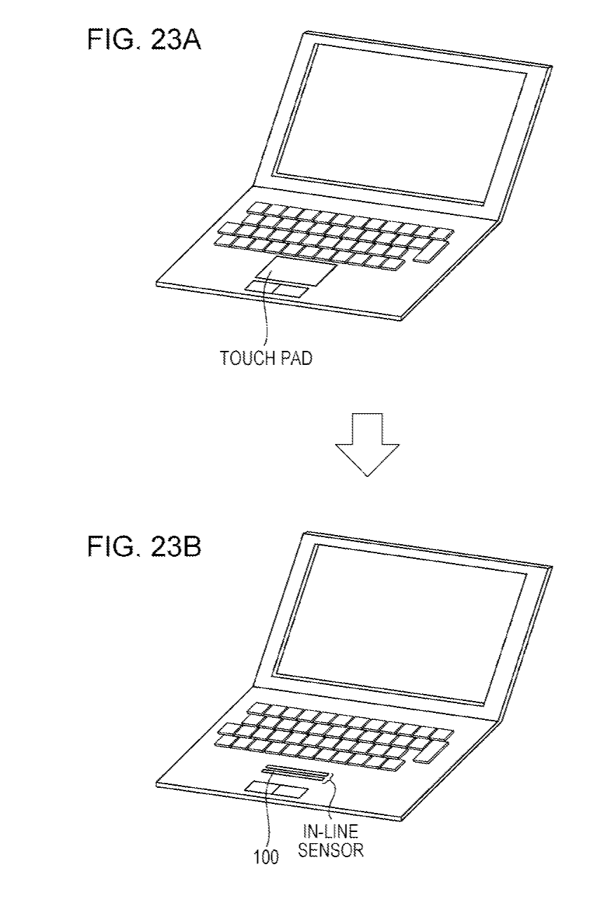

In FIG. 23A and FIG. 23B, an example of applying the information input device 100 according to the present embodiment to a notebook computer is illustrated. As illustrated in FIG. 23A, in the notebook computers, it was common to equip with a touch pad in front of the key board of the main body for inputting the two dimensional coordinates. On the other hand, as illustrated in FIG. 23B, the touch pad can be replaced by the information input device 100. As illustrated in Figures, only a line-shaped operator 110 is appeared on the upper surface of the main body, the occupying area may be smaller compared to the touch pad. In addition, in the palm posture with the right and left index fingers on the home positions of the keyboard such as “F” and “J” keys, the coordinates input operation is mainly performed using the thumbs. However, the operation of moving the fingers in the vertical direction (depth direction of the main body) is difficult. In contrast, in the information input device 100 according to the present embodiment, the input operation is basically performed by moving the fingers in the horizontal direction, and the moving amount in the vertical direction is small. Accordingly, the operability can be improved even in the posture with the index fingers on the home position of the keyboard.

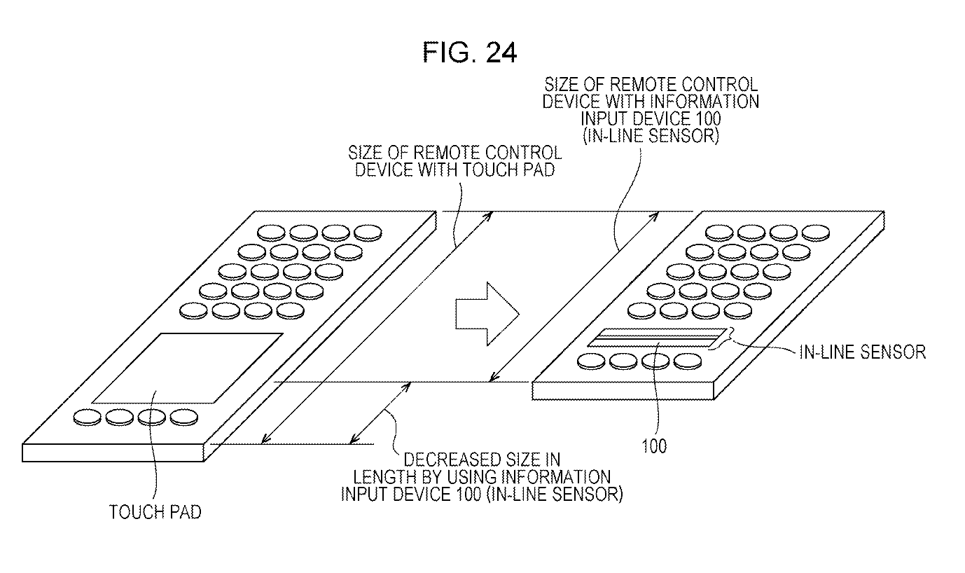

In addition, in FIG. 24, an example of applying the information input device 100 according to the embodiment to a remote control device is illustrated. As illustrated in FIG. 24, only a line-shaped operator 110 appears on the upper surface of the main body. For reference, an example of installing the touch panel for two dimensional inputting on the main body of remote control device is illustrated in FIG. 24. Comparing the right and left remote control devices in FIG. 24, by using the information input device 100, it is apparent that the size of the remote control device in height direction is decreased, and the bottom area is decreased. Therefore, it is apparent that the information input device 100 can contribute the miniaturization of the remote control device. Furthermore, in the example in FIG. 24, the operator 110 of the information input device 100 is provided to be inserted between the buttons array on the upper surface of the remote control device. However, the operator 110 may be disposed on the front edge of the upper surface or along the end edge of the right or left end of the remote control device.

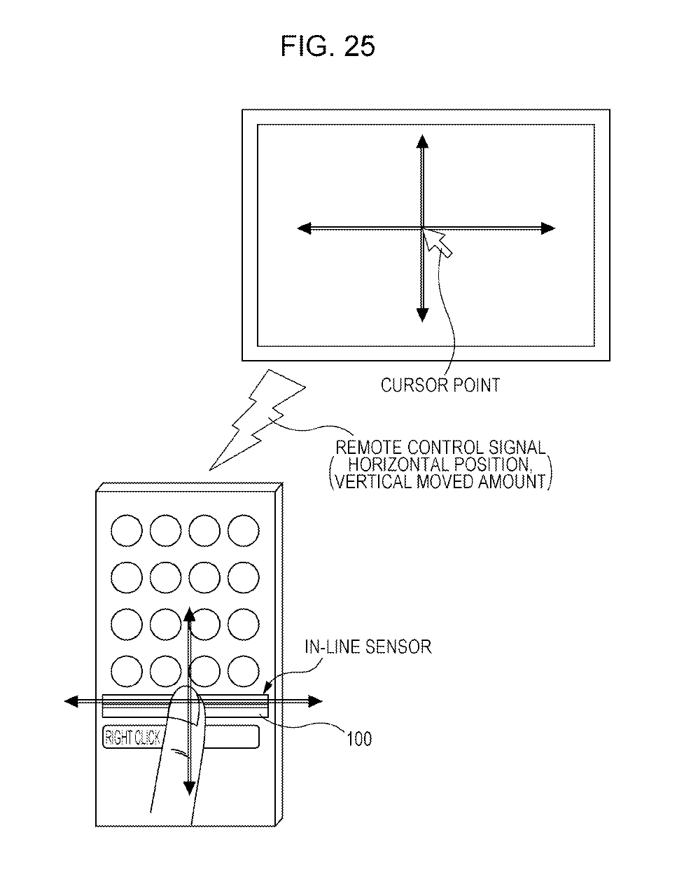

In addition, in FIG. 25, a state of moving a pointer on the TV screen using the information input device 100 on the remote control device illustrated in FIG. 24. When the user's fingertip operation is performed with respect to the operator 110 of the information input device 100, the remote control device specifies the absolute coordinates in the horizontal direction and calculates the moving amount in the vertical direction to transmit the remote control signal to the TV receiver according to the process order illustrated in FIG. 22, for example. Then, in the TV receiver side, the pointer on the screen is moved based on the received data.

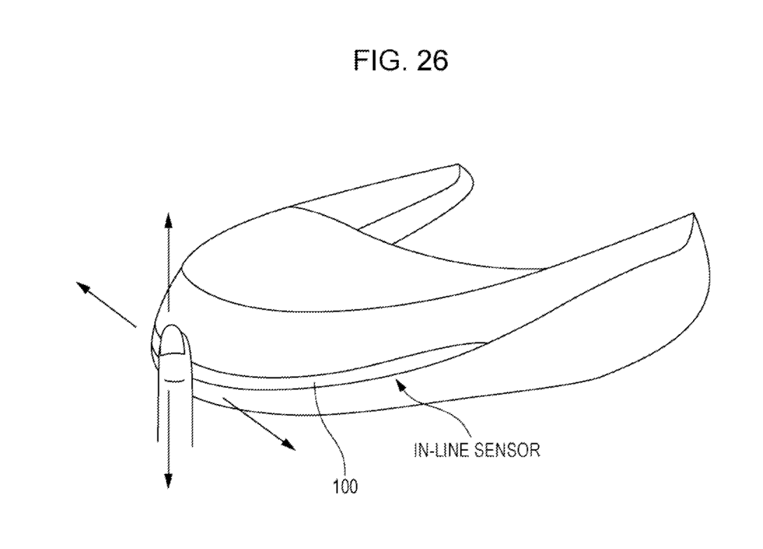

In addition, in FIG. 26, an example of applying the information input device 100 according to the embodiments to ahead mounting type display apparatus is illustrated. The head mounting type image display apparatus is configured to be able to control the sight and hearing by including a image display unit for each of the right and left eye-stogether with a headphone (widely opened). In case of an “immersive” head mounting type display apparatus which directly covers the eyes of the user, the input operation is to be performed in a blindfolded state while watching the image, there is a possibility of erroneous operation of the apparatus due to the mistake in pushing the buttons. In addition, the user in blindfolded state may be in a state to operate in at least two steps, firstly finding by a finger and selecting the target on the touch sensor and next performing the operation. Thus the operability is not so good. In contrast, in the head mounting type display apparatus as illustrated in FIG. 26, the operator 110 of the information input device 100 is disposed on the position that is the front surface of head when the user mounts it on the head.

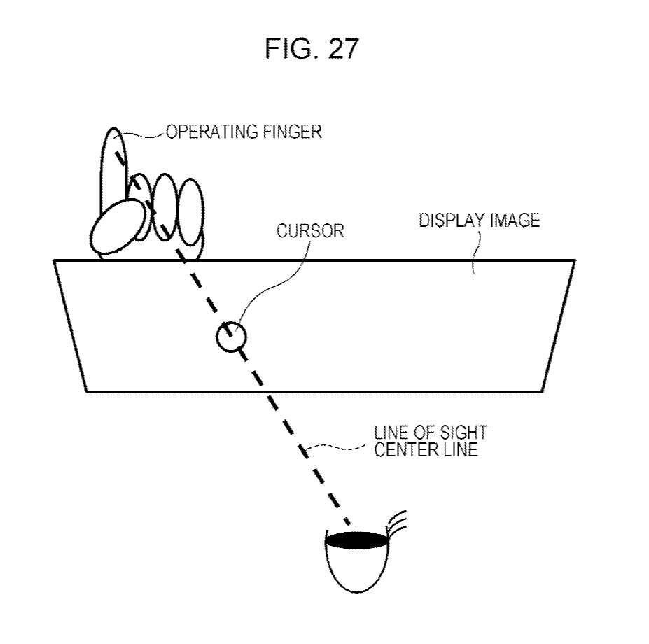

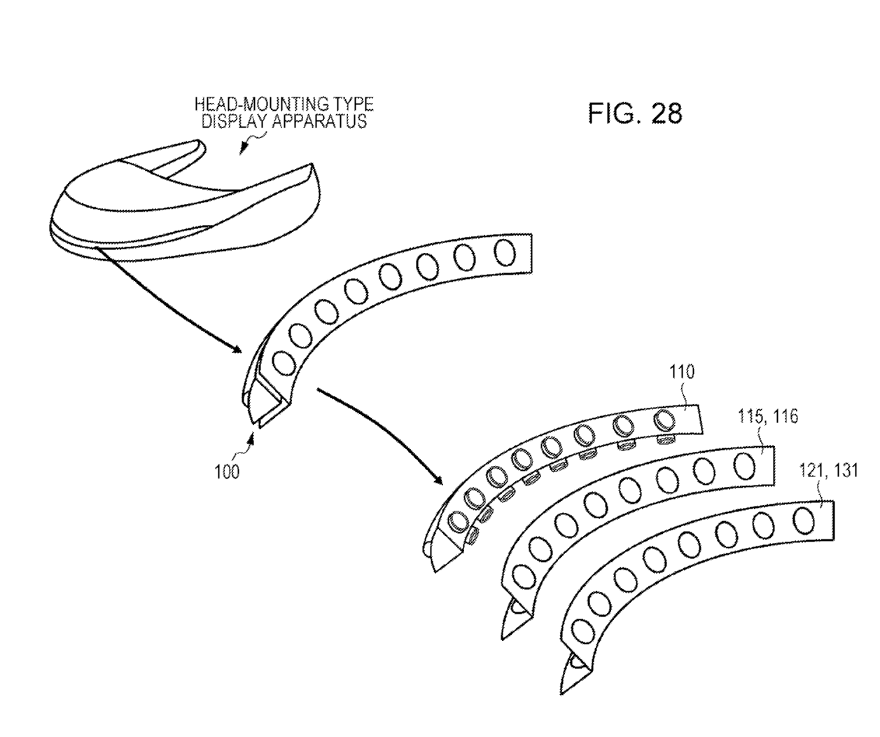

For example, on the display image for left eye and the display image for right eye, in a case when displaying the cursor on the horizontal position corresponding to the position touched by the finger on the operator 110, the user can search the desired target with a feeling of touching the display image from the rear surface by placing the cursor such that the center line of the line of sight, the cursor and the operating finger are aligned in a straight line (on the display image fused in the user's brain) as illustrated in FIG. 27.

The user can intuitively search the desired target by a touching operation of the operation unit even in a blindfolded state in which the user is not able to see the operation unit. The user can complete the operation in one step operation such as the user's direct touching of the desired target. Accordingly, the operability can be improved.

Furthermore, the information input device 100 illustrated in FIG. 1 and FIG. 2, is configured to be comparatively short in length and to have a line shape. On the other hand, in a case where the information input device 100 is disposed throughout both right and left ends of the front surface of the head mounting type display apparatus as illustrated in FIG. 27, it may be necessary for the information input device 100 to be installed in a curved shape. In FIG. 28, a configuration example of the information input device 100 installed in the curved shape is illustrated.

As described above, the information input device 100 is capable of inputting the operation amount in two dimensions or in two directions with the user's fingertip by using the two in-line sensors 120 and 130 each disposed in parallel, depite that the device is in a line shape. Thus, it is possible to perform the position determination in a plane. In addition, the information input device 100 can be installed in the small area on the information apparatuses owing to the lineshape.

Furthermore, the present disclosure can be configured as described below.

1. An information input device including:

an operator on which a user operates a sliding operation in a first direction, a first detection unit that is disposed at a rear surface of the operator and detects a position and a pressure of the sliding operation operated by the user on the operator in the first direction, a second detection unit that is disposed adjacent to the first detection unit so as to be parallel to the first direction at the rear surface of the operator, and detects a position and a pressure of the sliding operation operated by the user on the operator in the first direction, and a position measurement unit that measures an instructed position in the first direction based on the slide position detected by at least one of the first detection unit or the second detection unit, and measures an instructed position in a second direction orthogonal to the first direction based on a difference of the pressures detected by the first detection unit and the second detection unit respectively.

2. The information input device according to above 1, in which the rear surface of the operator includes a first opposing surface and a second opposing surface that are parallel to the first direction and intersect at a predetermined angle respectively, and in which the first detection unit is disposed opposing the first opposing surface and the second detection unit is disposed opposing the second opposing surface, respectively.

3. The information input device according to above 2, in which the operator is formed of an elastic material and propagates the pressure applied to the slide position by the user in the first direction, to the first detection unit and the second detection unit.

4. The information input device according to above 3, in which the first detection unit and the second detection unit respectively includes a plurality of pressure-sensitive elements arranged along the first direction, and in which the position measurement unit-measures the instructed position in the first direction based on the output of the position in the first direction detected by the pressure-sensitive element, on which the detection level peaks, in the first detection unit or the second detection unit, and calculates an instructed position in a second direction based on the difference between the detection level by the pressure-sensitive elements of the first detection unit and the second detection unit which are located on the same position in the first direction.

5. The information input device according to above 4, in which the first detection unit is formed of a plurality of pressure-sensitive elements arranged on a first substrate disposed opposing the first opposing surface of the operator along the first direction, and in which the second detection unit is formed of a plurality of pressure-sensitive elements arranged on a second substrate disposed opposing the second opposing surface of the operator along the first direction.

6. The information input device according to above 5, in which each pressure-sensitive element of the first detection unit is formed of a pressure conductive rubber or a pressure conductive carbon print disposed on the first substrate, and contacts with a conductor pattern formed on the corresponding position to the first opposing surface to change a resistance value between both ends thereof according to the applied pressure, in which each pressure-sensitive element of the second detection unit is formed of a pressure conductive rubber or a pressure conductive carbon print disposed on the second substrate, and contacts with a conductor pattern formed on the corresponding position to the second opposing surface to change a resistance value between both ends thereof according to the applied pressure, and in which the position measurement unit calculates a pressing pressure based on the resistance value of each pressure-sensitive element.

7. The information input device according to above 6, in which the operator includes a protrusion formed with the conductor pattern on an upper surface respectively, on the corresponding position to each of the pressure-sensitive elements on the first-substrates of the first opposing surface and includes a protrusion formed on the corresponding position to each of the pressure-sensitive elements on the second substrates of the second opposing surface with the conductor pattern on an upper surface respectively.

8. The information input device according to above 6, in which the operator includes a slit that separates each conductor pattern formed on the first opposing surface and the second opposing surface.

9. An information processing apparatus, including; an information input unit which includes an operator on which a user operates a sliding operation in a first direction, a first detection unit that is disposed at a rear surface of the operator and detects a position and a pressure of the sliding operation operated by the user on the operator in the first direction, a second detection unit that is disposed adjacent to the first detection unit so as to be parallel to the first direction at the rear surface of the operator, and detects a position and a pressure of the sliding operation operated by the user on the operator in the first direction, and a position measurement unit that measures an instructed position in the first direction based on the slide position detected by at least one of the first detection unit or the second detection unit, and measures an instructed position in a second direction orthogonal to the first direction based on a difference of the pressures detected by the first detection unit and the second detection unit respectively, a display unit, and a control unit that controls a screen display on the display unit based on the instructed position in the first direction and the instructed position in the second direction obtained by the information input unit.

10. The information processing apparatus according to above 9, further including; a mounting unit that mounts a main body of information processing apparatus main body on the user's head such that the display unit displays an image toward the left and right eyes of the user.

11. The information processing apparatus according to above 10, in which the control unit makes a cursor which indicates a horizontally contacted position on the input unit be displayed in the displayed image on the display unit, in response to the contact of the hand fingers to the input unit by the user.

12. A remote control system including; a remote control device that includes an operator on which a user operates a sliding operation in a first direction, a first detection unit that is disposed at a rear surface of the operator and detects a position and a pressure of the sliding operation by the user on the operator in the first direction, a second detection unit that is disposed adjacent to the first detection unit so as to be parallel to the first direction at the rear surface of the operator, and detects a position and a pressure of the sliding operation by the user on the operator in the first direction, a position measurement unit that measures an instructed position in the first direction based on the slide position detected by at least one of the first detection unit or the second detection unit, and measures an instructed position in a second direction orthogonal to the first direction based on a difference of the pressures detected by the first detection unit and the second detection unit respectively, and a transmission unit for-transmitting a remote control signal based on the instructed position in the first direction and the instructed position in the second direction measured by the position measurement unit, and a display device that includes a display unit, a receiving unit for receiving the remote control signal from the remote control device, and a control unit that controls a screen display on the display unit based on the remote control signal received by the receiving unit.

The present disclosure contains subject matter related to that disclosed in Japanese Priority Patent Application JP 2012-150701 filed in the Japan Patent Office on Jul. 4, 2012, the entire contents of which are hereby incorporated by reference.

### INDUSTRIAL APPLICABILITY

As described above, with reference to a specific embodiment, the present disclosure is described in detail. However, it is apparent that those skilled in the art can make modifications and substitutions of the embodiments without departing from the scope of the present disclosure.

The information input device 100 disclosed in the description may be mounted in a space-saving manner on various information equipments having a main body with a small size such as a personal computer and a multi-functional mobile terminal, and it is possible to realize the two-dimensional coordinates input. Of course, the information input device 100 can also be used in other information equipments a main body of which is not so small.

In short, the present disclosure is described by way of exemplary embodiments, and it should not be construed as limiting the description herein. In order to determine the scope of the present disclosure herein, it should be referred to the claims appended hereto.

### REFERENCE SIGNS LIST

100 Information input device
110 Operator
111 Operation surface
112 Guide section
113 First opposing surface
114 Second opposing surface
115, 116 Spacer
117-1, 117-2, . . . , 117-N Conductor pattern
118-1, 118-2, . . . , 118-N Conductor pattern
120 First in-line sensor
121 Substrate
122-1, 122-2, . . . , 122-N Sensor element
130 Second in-line sensor
131 Substrate
132-1, 132-2, . . . , 132-N Sensor element

1. An information input device comprising:
an operator on which a user operates a sliding operation in a first direction;
a first detection unit that is disposed at a rear surface of the operator and detects a position and a pressure of the sliding operation operated by the user on the operator in the first direction;
a second detection unit that is disposed adjacent to the first detection unit so as to be parallel to the first direction at the rear surface of the operator, and detects a position and a pressure of the sliding operation operated by the user on the operator in the first direction;
a position measurement unit that measures an instructed position in the first direction based on the slide position detected by at least one of the first detection unit or the second detection unit, and measures an instructed position in a second direction orthogonal to the first direction based on a difference of the pressures detected by the first detection unit and the second detection unit respectively.

2. The information input device according to claim 1,
wherein the rear surface of the operator includes a first opposing surface and a second opposing surface that are parallel to the first direction and intersect at a predetermined angle respectively, and
wherein the first detection unit is disposed opposing the first opposing surface and the second detection unit is disposed opposing the second opposing surface, respectively.

3. The information input device according to claim 2,
wherein the operator is formed of an elastic material and propagates the pressure applied to the slide position by the user in the first direction, to the first detection unit and the second detection unit.

4. The information input device according to claim 3,
wherein the first detection unit and the second detection unit respectively includes a plurality of pressure-sensitive elements arranged along the first direction, and
wherein the position measurement unit measures the instructed position in the first direction based on the output of the position in the first direction detected by the pressure-sensitive element, on which the detection level peaks, in the first detection unit or the second detection unit, and calculates an instructed position in a second direction based on the difference between the detection level by the pressure-sensitive elements of the first detection unit and the second detection unit which are located on the same position in the first direction.

5. The information input device according to claim 4,
wherein the first detection unit is formed of a plurality of pressure-sensitive elements arranged on a first substrate disposed opposing the first opposing surface of the operator along the first direction, and wherein the second detection unit is formed of a plurality of pressure-sensitive elements arranged on a second substrate disposed opposing the second opposing surface of the operator along the first direction.

6. The information input device according to claim 5,
wherein each pressure-sensitive element of the first detection unit is formed of a pressure conductive rubber or a pressure conductive carbon print disposed on the first substrate, and contacts with a conductor pattern formed on the corresponding position to the first opposing surface to change a resistance value between both ends thereof according to the applied pressure,
wherein each pressure-sensitive element of the second detection unit is formed of a pressure conductive rubber or a pressure conductive carbon print disposed on the second substrate, and contacts with a conductor pattern formed on the corresponding position to the second opposing surface to change a resistance value between both ends thereof according to the applied pressure, and
wherein the position measurement unit calculates a pressing pressure based on the resistance value of each pressure-sensitive element.

7. The information input device according to claim 6,
wherein the operator includes a protrusion formed on the corresponding position to each of the pressure-sensitive elements on the first substrates of the first opposing surface with the conductor pattern on an upper surface respectively, and includes a protrusion formed on the corresponding position to each of the pressure-sensitive elements on the second substrates of the second opposing surface with the conductor pattern on an upper surface respectively.

8. The information input device according to claim 6,
wherein the operator includes a slit that separates each conductor pattern formed on the first opposing surface and the second opposing surface.

9. An information processing apparatus, comprising:
an information input unit which includes an operator on which a user operates a sliding operation in a first direction, a first detection unit that is disposed at a rear surface of the operator and detects a position and a pressure of the sliding operation operated by the user on the operator in the first direction, a second detection unit that is disposed adjacent to the first detection unit so as to be parallel to the first direction at the rear surface of the operator, and detects a position and a pressure of the sliding operation operated by the user on the operator in the first direction, and a position measurement unit that measures an instructed position in the first direction based on the slide position detected by at least one of the first detection unit or the second detection unit, and measures an instructed position in a second direction orthogonal to the first direction based on a difference of the pressures detected by the first detection unit and the second detection unit respectively;
a display unit; and
a control unit that controls a screen display on the display unit based on the instructed position in the first direction and the instructed position in the second direction obtained by the information input unit.

10. The information processing apparatus according to claim 9, further comprising:
a mounting unit that mounts a main body of information processing apparatus main body on the user's head such that the display unit-displays an image toward the right and left eyes of the user.

11. The information processing apparatus according to claim 10,
wherein the control unit makes a cursor indicating a contacted horizontal position on the input unit be displayed in the displayed image on the display unit, in response to the contact of the hand fingers to the input unit by the user.

12. A remote control system comprising:
a remote control device that includes an operator on which a user operates a sliding operation in a first direction, a first detection unit that is disposed at a rear surface of the operator and detects a position and a pressure of the sliding operation by the user on the operator in the first direction, a second detection unit that is disposed adjacent to the first-detection unit so as to be parallel to the first direction at the rear surface of the operator, and detects a position and a pressure of the sliding operation by the user on the operator in the first direction, a position measurement unit that measures an instructed position in the first direction based on the slide position detected by at least one of the first detection unit or the second detection unit, and measures an instructed position in a second direction orthogonal to the first direction based on a difference of the pressures detected by the first detection unit and the second detection unit respectively, and a transmission unit for transmitting a remote control signal based on the instructed position in the first direction and the instructed position in the second direction-measured by the position measurement unit; and
a display device that includes a display unit, a receiving unit for receiving the remote control signal from the remote control device, and a control unit that controls a screen display on the display unit based on the remote control signal received by the receiving unit.
